(19) United States
(12) Patent Application Publication
(10) Pub. No.: US 2007/0067377 A1
(43) Pub. Date: Mar. 22, 2007

(54) METHODS, DEVICES, AND PROGRAMS FOR DESIGNING A DIGITAL FILTER AND FOR GENERATING A NUMERICAL SEQUENCE OF DESIRED FREQUENCY CHARACTERISTICS

(75) Inventor: Yukio KOYANAGI, Saitama-shi (JP)

Correspondence Address: CONNOLLY BOVE LODGE & HUTZ LLP, P.O. BOX 2207, WILMINGTON, DE, 19899-2207, US

(73) Assignee: Neuro Solution Corp., Tokyo (JP)

(21) Appl. No.: 11/550,345

(22) Filed: Oct. 17, 2006

Related U.S. Application Data
(63) Continuation of application No. PCT/JP04/17667, filed on Nov. 22, 2004.

(30) Foreign Application Priority Data
Apr. 19, 2004 (JP) 2004-123245

(51) Int. Cl. G06F 17/10

(52) U.S. Cl. 708/300

(57) ABSTRACT

A standard function is inputted and an interpolation function of finite length is calculated therefrom. Then, the frequency characteristics of the interpolation function is shifted by a desired amount in the frequency axis direction, thereby determining input frequency characteristics based on specification. Filter coefficients are determined by performing inverse FFT of a numerical sequence representative of the input frequency characteristics and rounding is performed according to the coefficient values in order to obtain a smaller number of filter coefficients. Thus, it is possible to eliminate the need for windowing as an operation for decreasing the number of filter coefficients and easily design an FIR filter having desired frequency characteristics.

### TECHNICAL FIELD

The present invention relates to a method and device for designing a digital filter, a program for designing a digital filter, a digital filter, a method and device for generating a numerical sequence of a desired frequency characteristic, and a program for generating a numerical sequence of a desired frequency characteristic, and in particular, to an FIR filter of a type that comprises tapped delay line made up of a plurality of delayers and which multiplies signals from respective taps severalfold and adds up multiplication results for output, and a method of designing this filter, as well as a method for generating a numerical sequence which is used to design the filter and which indicates an input frequency characteristic.

### BACKGROUND ART

Various kinds of electronical devices provided in a variety of technical fields normally implement digital signal processing of some sort in their inside. The most important basic operations of digital signal processing include filtering processing of taking only signals within a required certain frequency band out of input signals in which respective kinds of signals and noises are mixed. Therefore, digital filters are frequently used in electronics devices of implementing digital signal processing.

IIR (Infinite Impulse Response) filters and FIR (Finite Impulse Response) filters are mostly used as digital filters. Among them, the FIR filters are advantageous as follows. Firstly the circuit is always stable since the pole of transfer function of an FIR filter is located only in the origin of the z plane. Secondly, if the filter coefficients are of a symmetrical type, it is possible to realize a completely accurate linear-phase characteristic.

In this FIR filter, the impulse response expressed in finite time length will straight be the filter coefficients. Accordingly, designing an FIR filter means to determine the filter coefficients so as to obtain a desired frequency characteristic. Several methods for calculating filter coefficients have been proposed.

For example, one of these methods determines filter coefficients by a convolution or the like using a Chebyshev approximation on the basis of the ratio of a sampling frequency to a cutoff frequency for a desired frequency characteristic. Another method determines filter characteristics by inputting a waveform for a desired frequency characteristic in the form of a numerical sequence or a function, subjecting the input numerical sequence or function to an inverse Fourier transformation (inverse FFT), and extracting real items from the result (see, for example, Patent Documents 1 and 2).

Patent Document 1: Japanese Patent Laid-Open No. 63-234617

Patent Document 2: Japanese Patent Laid-Open No. 2003-168958

However, the above conventional techniques determine an enormous number of filter coefficients of very complicated, random values. Thus, using all the filter coefficients obtained sharply increases the number of taps in a filter circuit and requires a large number of multipliers to subject the complicated, random filter coefficient values to multiplication. In other words, the above technique requires a large-scale circuit configuration. This is not practical. Thus, the filter coefficients need to be reduced to an appropriate number in a practical sense by means of windowing using a window function.

However, the windowing for a reduction in filter coefficients often discretize the filter coefficients, which significantly affect the frequency characteristic. This prevents an appropriate target frequency characteristic from being obtained. Further, the method of determining a filter coefficient subjecting the numerical sequence of an input waveform to an inverse FFT determines a frequency characteristic depending on the numerical sequence or function that expresses the input waveform. However, the determination of the numerical sequence or function is itself difficult. Thus, it is disadvantageously very difficult to offer a desired frequency characteristic regardless of whichever conventional filter designing method is used.

To obtain a desired frequency characteristic by the conventional filter designing method based on windowing, a trial and error process needs to be executed by subjecting temporarily determined filter coefficients to an FFT with the resulting frequency characteristic checked. In particular, with a technique for subjecting an input waveform to an inverse FFT, the numerical sequence or function of the input waveform must itself be determined through a trial and error process. Thus, disadvantageously, the conventional techniques require a skilled technician to put much time and effort in designing an FIR filter. This prevents an FIR filter with a desired characteristic from being easily designed.

### DISCLOSURE OF THE INVENTION

The present invention has been made in order to solve the above problems. An object of the present invention is to allow an FIR digital filter to be easily designed with almost no trial and error processes, the FIR digital filter involving a reduced number of filter coefficients and enabling a desired frequency characteristic to be accurately provided using a small-scale circuit.

To accomplish the object, the present invention inputs a standard function to a circuit and calculates an interpolation function of a finite length from the standard function to determine an input frequency characteristic based on specifications. The present invention then subjects a numerical sequence indicative of the input frequency characteristic to an inverse Fourier transformation to obtain filter coefficients. The present invention then executes a rounding process based on the coefficient values to obtain a reduced number of filter coefficients depending on the number of process bits.

The present invention configured as described above allows an FIR digital filter having a desired frequency characteristic to be easily designed without any expertise; examples of such an FIR digital filter include a low pass filter, a high pass filter, a band pass filter, and a band elimination filter. The present invention doesn't require the windowing for reducing the number of filter coefficients. The present invention uses a numerical rounding operation to enable the number of filter coefficients (the number of taps for the digital filter) to be reduced without lowering the accuracy of the frequency characteristic. That is, the present invention enables an FIR filter with an appropriate frequency characteristic to be easily designed; the FIR filter requires a reduced number of taps and offers a pass band characteristic that allows ripple to be minimized as well as a uniform attenuation characteristic.

### BRIEF DESCRIPTION OF THE DRAWINGS

FIG. 1 is a flowchart showing a process procedure of a method of designing a digital filter according to the present embodiment;

FIG. 2 is a flowchart showing a procedure of calculating an input frequency characteristic according to a first generation method in step S1 in FIG. 1;

FIG. 3 is a flowchart showing a procedure of calculating an input frequency characteristic according to a second generation method in step S1 in FIG. 1;

FIG. 4 is a diagram showing the frequency amplitude characteristic of an interpolation function (low pass filter based on design specifications) generated according to the second generation method;

FIG. 5 is a diagram illustrating a rearranging process in step S3 in FIG. 1;

FIG. 6 is a diagram showing an example of a standard function for a low pass filter which is input in step S11 in FIG. 2;

FIG. 7 is a diagram showing an example of an interpolation function calculated from the standard function in FIG. 6;

FIG. 8 is a diagram showing a frequency characteristic obtained by shifting the interpolation function in FIG. 7 by a desired amount;

FIG. 9 is a diagram showing an input frequency characteristic generated by converting the frequency characteristic in FIG. 8 into a laterally symmetric type;

FIG. 10 is a diagram showing the distribution of filter coefficients (which have not been subjected to a rounding process) for a low pass filter according to specifications shown in FIG. 46, which have been determined from the standard function shown in FIG. 6, according to the filter designing method of the present embodiment;

FIG. 11 is an enlarged diagram showing the distribution of filter coefficients obtained by performing a rounding operation on the filter coefficients shown in FIG. 10;

FIG. 12 is a diagram showing the frequency amplitude characteristic of an FIR low pass filter implemented using the filter coefficients shown in FIG. 11;

FIG. 13 is a diagram showing another example of a standard function for a low pass filter which is input in step S11 in FIG. 2 and an interpolation function calculated from the standard function;

FIG. 14 is a diagram showing another example of a standard function for a low pass filter which is input in step S11 in FIG. 2 and an interpolation function calculated from the standard function;

FIG. 15 is a diagram showing the distribution of filter coefficients (which have not been subjected to a rounding process) for a low pass filter according to specifications shown in FIG. 46, which have been determined from the standard function shown in FIG. 13, according to the filter designing method of the present embodiment;

FIG. 16 is a diagram showing the distribution of filter coefficients (which have not been subjected to a rounding process) for the low pass filter according to specifications shown in FIG. 46, which have been determined from the standard function shown in FIG. 14, according to the filter designing method of the present embodiment;

FIG. 17 is a diagram showing an example of a standard function for a high pass filter which is input in step S11 in FIG. 2;

FIG. 18 is a diagram showing an example of an interpolation function calculated from the standard function in FIG. 17;

FIG. 19 is a diagram showing a frequency characteristic obtained by shifting the interpolation function in FIG. 18 by a desired amount;

FIG. 20 is a diagram showing an input frequency characteristic generated by converting the frequency characteristic in FIG. 19 into a laterally symmetric type;

FIG. 21 is a diagram showing the frequency amplitude characteristic of an interpolation function (high pass filter based on design specifications) generated by the second generation method;

FIG. 22 is a diagram showing the distribution of filter coefficients (which have not been subjected to a rounding process) for a high pass filter according to specifications shown in FIG. 47, which have been determined from the standard function shown in FIG. 17, according to the filter designing method of the present embodiment;

FIG. 23 is an enlarged diagram showing the distribution of filter coefficients obtained by performing a rounding operation on the filter coefficients shown in FIG. 22;

FIG. 24 is a diagram showing the frequency amplitude characteristic of an FIR high pass filter implemented using the filter coefficients shown in FIG. 23;

FIG. 25 is a diagram showing an example of an interpolation function calculated from the standard functions in FIGS. 6 and 17 to design a band pass filter according to specifications shown in FIG. 48;

FIG. 26 is a diagram showing a frequency characteristic obtained by shifting the interpolation function in FIG. 25 by a desired amount;

FIG. 27 is a diagram showing an input frequency characteristic generated by converting the frequency characteristic in FIG. 26 into a laterally symmetric type;

FIG. 28 is a diagram showing the frequency amplitude characteristic of an interpolation function (band pass filter based on design specifications) generated by the second generation method;

FIG. 29 is a diagram showing the distribution of filter coefficients (which have not been subjected to a rounding process) for a high pass filter according to specifications shown in FIG. 48, which have been determined from the interpolation function shown in FIG. 25, according to the filter designing method of the present embodiment;

FIG. 30 is an enlarged diagram showing the distribution of filter coefficients obtained by performing a rounding operation on the filter coefficients shown in FIG. 29;

FIG. 31 is a diagram showing the frequency amplitude characteristic of an FIR band pass filter implemented using the filter coefficients shown in FIG. 30;

FIG. 32 is a diagram showing an example of another standard function for a low pass filter which is input in step S11 in FIG. 2;

FIG. 33 is a diagram showing an example of an interpolation function calculated from the standard function in FIG. 32;

FIG. 34 is a diagram showing another example of a standard function for a low pass filter which is input in step S11 in FIG. 2 and of an interpolation function calculated from the standard function;

FIG. 35 is a diagram showing the distribution of filter coefficients (which have not been subjected to a rounding process) for a low pass filter according to specifications shown in FIG. 46, which have been determined from the standard function shown in FIG. 34, according to the filter designing method of the present embodiment;

FIG. 36 is a diagram showing another example of a standard function for a low pass filter which is input in step S11 in FIG. 2 and of an interpolation function calculated from the standard function;

FIG. 37 is a diagram showing the distribution of filter coefficients (which have not been subjected to a rounding process) for a low pass filter according to specifications shown in FIG. 46, which have been determined from the standard function shown in FIG. 36, according to the filter designing method of the present embodiment;

FIG. 38 is a diagram showing an example of yet another standard function for a low pass filter which is input in step S11 in FIG. 2;

FIG. 39 is a diagram showing an example of an interpolation function calculated from the standard function in FIG. 38;

FIG. 40 is a diagram showing three types of standard functions, three types of interpolation functions calculated from the standard functions, and the distributions of three types of filter coefficients obtained by executing an inverse FFT on input frequency characteristics determined by shifting the interpolation functions;

FIG. 41 is a diagram showing the relationship between the value of x (the number of bits x resulting from rounding) which is used for a rounding operation and the required tap number;

FIG. 42 is a diagram showing an example of configuration of a digital filter according to the present embodiment;

FIG. 43 is a block diagram showing another example of configuration of a digital filter according to the present embodiment;

FIG. 44 is a block diagram showing another example of configuration of a digital filter according to the present embodiment;

FIG. 45 is a block diagram showing another example of configuration of a digital filter according to the present embodiment;

FIG. 46 is a diagram showing an example of design specifications for a low pass filter;

FIG. 47 is a diagram showing an example of design specifications for a high pass filter; and

FIG. 48 is a diagram showing an example of design specifications for a band pass filter.

### BEST MODE FOR CARRYING OUT THE INVENTION

An embodiment of the present invention will be described with reference to the drawings. FIG. 1 is a flowchart showing a process procedure of a method of designing a digital filter according to the present embodiment. A digital filter to be designed is an FIR filter of a type that comprises a tapped delay line made up of a plurality of delayers and which multiplies signals from respective taps severalfold and adds up multiplication results for output. The flowchart in FIG. 1 shows a method for determining filter coefficients for an FIR filter.

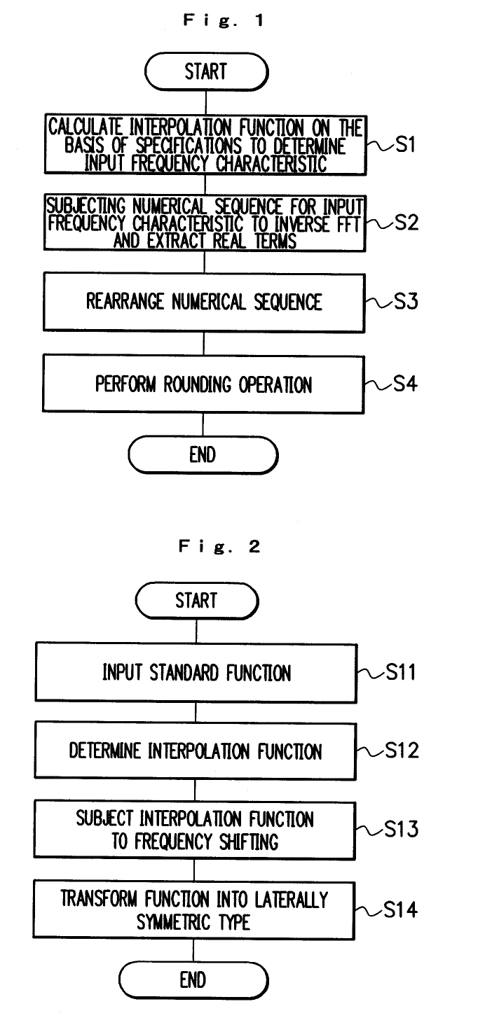

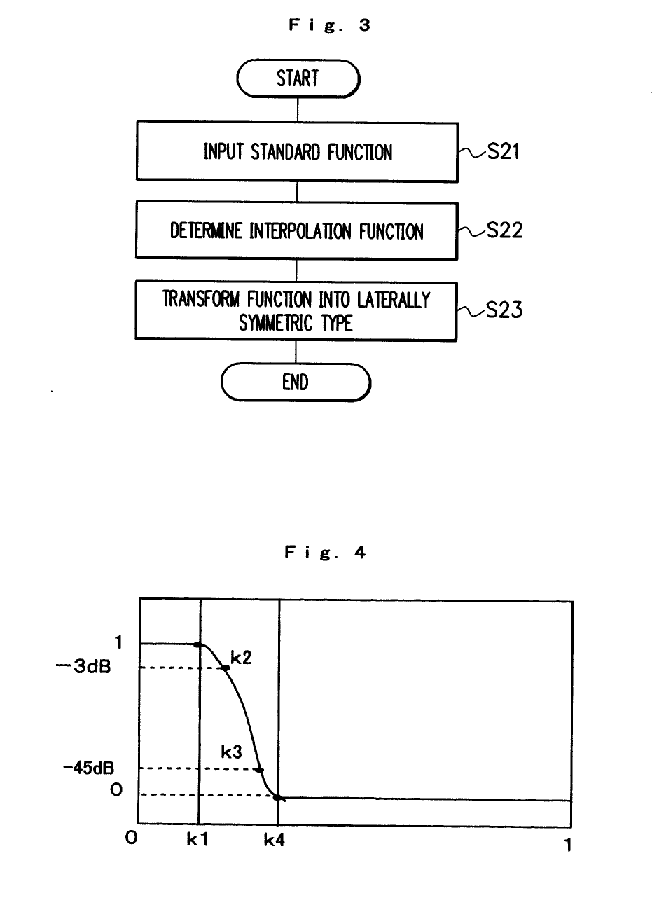

As shown in FIG. 1, first, an interpolation function is calculated on the basis of specifications for a filter to be designed. The calculated interpolation function is then used to determine an input frequency characteristic (step S1). The interpolation function to be calculated interpolates the range between the maximum and minimum amplitude values for a frequency amplitude characteristic based on the specifications for the filter to be designed. The input frequency characteristic determined by the interpolation function represents the frequency characteristic itself of the filter to be designed. A method for calculating the interpolation function will be described below in detail with reference to the flowcharts in FIGS. 2 and 3.

Then, a numerical sequence determined by the thus input interpolation function is subjected to an inverse FFT, with the resulting real items extracted (step S2). As is well known, executing an FFT process on a numerical sequence results in a frequency characteristic corresponding to the numerical sequence. Accordingly, an inverse FFT is executed on a numerical sequence indicating a frequency characteristic which is input through the interpolation function and the resulting real items are extracted, the numerical sequences required to provide the input frequency characteristic are obtained. These numerical sequences correspond to filter coefficients to be determined.

However, the numerical sequences themselves, determined, by an inverse FFT, from the interpolation function calculated in step S1, are not always configured so that their values are arranged so as to be directly used as filter coefficients. Specifically, for any types of digital filters, the numerical sequences of filter coefficients are symmetric so that their central value is largest and so that the other values decrease consistently with increasing distance from the central value, with amplitude repeated. In contrast, numerical sequences determined from the interpolation function by an inverse FFT have the smallest value in the center and the largest value at the ends of the distribution.

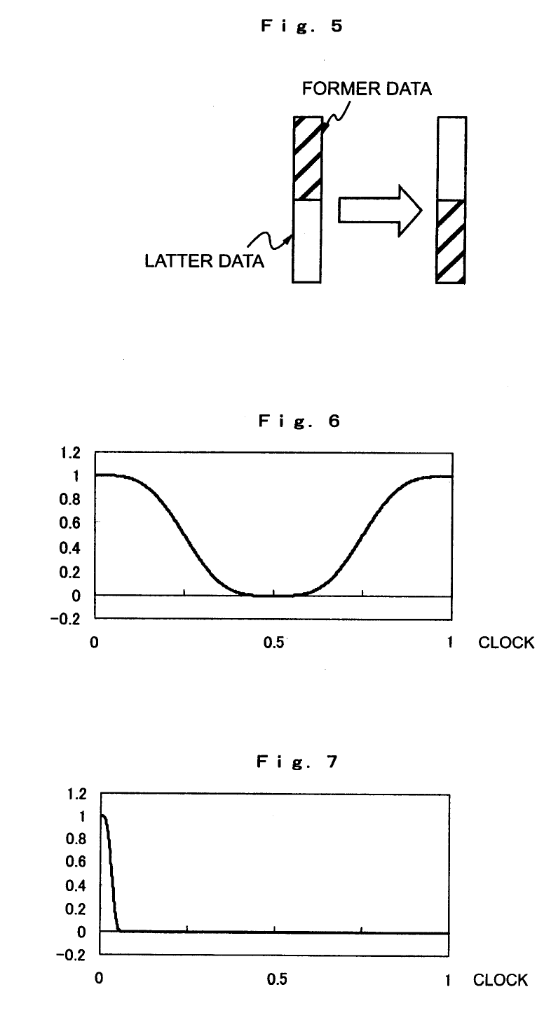

Thus, as shown in FIG. 5, in order that the maximum value of the numerical sequences determined by an inverse FFT is located in the center of the distribution, the numerical sequences are divided into a former part and a latter part, with their values rearranged (step S3).

The numerical sequences thus obtained can be determined to be target filter coefficients as they are. However, the present embodiment further performs a rounding operation described below to reduce the filter coefficients to a required number, and simplifying their values (step S4).

For example, if the numerical sequences resulting from the appropriate rearrangement in step S3 are y-bit data, the y-bit data is multiplied by a factor of 2^{X}, with the resulting decimal fractions rounded to integers. Thus, x-bit (x<y) integral data is obtained and utilized as filter coefficients. Alternatively, a rounding process may be executed on y-bit data to obtain x-bit (x<y) data, which may then be multiplied by a factor of 2^{X} to obtain integers.

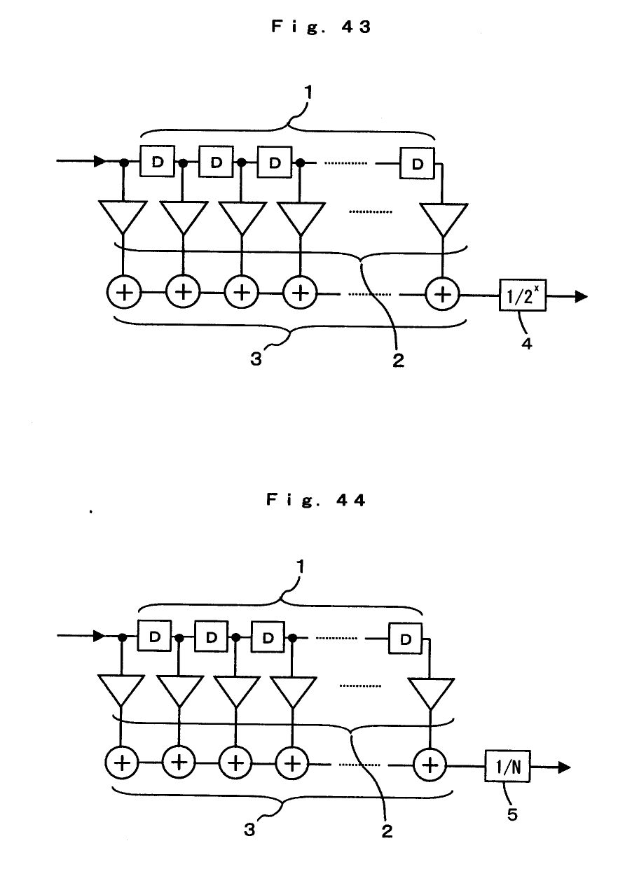

Performing such a rounding operation to obtain integers enables the digital filter to be configured as shown in FIG. 43 and described below. A plurality of coefficient multipliers 2 individually multiply output signals from the taps of a tapped delay line made up of a plurality of delayers (D-type flip flops) 1, by integral filter coefficients. A plurality of adders 3 then add up the multiplication outputs, and one shift operating unit 4 collectively multiplies the result by a factor of 1/2^{X. Further, the integral filter coefficients can be expressed by a binary addition such as} 2ⁱ+2ⁱ+ . . . (i and j are arbitrary integers). The coefficient multiplier 2 can thus be composed of a bit shift circuit in place of a multiplier. This makes it possible to sharply reduce multipliers, adders, and the like which are used in the whole FIR filter, thus drastically reducing the circuit scale of the digital filter.

The present embodiment determines the numerical sequences determined by such a rounding operation to be target filter coefficients. The above steps S3 and S4 need not necessarily be executed in this order but may be reversed.

Now, a method of calculating the input frequency characteristic in step 1 will be described in detail with reference to a specific example. Here, two methods of determining the input frequency characteristic are shown.

<First Generation Method>

FIG. 2 is a flowchart showing a procedure of calculating the input frequency characteristic in accordance with a first generation method, according to the present embodiment. In FIG. 2, first, a standard function is input to the circuit (step S11). Preferably, the input standard function is such that its impulse response has a finite value other than “0” only in a given area and a value of “0” in all the other areas, that is, the input standard function has a coefficient string having an impulse response with a value converging to “0” at a predetermined sample position.

The numerical sequence proposed by the present inventor and described in Japanese Patent Application No. 2003-56265 is an example of a coefficient string having a finite-base impulse response such that the impulse response has a finite value other than “0” in a local area and a value of “0” in the other areas. For example, to design a low pass filter according to specifications shown in FIG. 46, the numerical sequence described in Japanese Patent Application No. 2003-56265 is utilized to input such a function as shown in (Equation 1), as a standard function X_{F1}.
X_{F1}=8/16+9/16*cos(2πt)−1/16*cos(6πt) (Equation 1)

Here, the function shown in (Equation 1) is obtained by standardization using a maximum amplitude value of 1 and a maximum frequency value of 1. The coefficients {8/16, 9/16, 0, −1/16} (“0” is the coefficient of the item cos (4πt)) of the items of (Equation 1) constitute a numerical sequence corresponding to one of the halves into which the filter coefficients {−1, 0, 9, 16, 9, 0, −1}/16 of the low pass filter described in Japanese Patent Application No. 2003-56265 are divided at the center. As described in Japanese Patent Application No. 2003-56265 in detail, the impulse response from a low pass filter having the numerical sequence {−1, 0, 9, 16, 9, 0, −1}/16 as filter coefficients is of a finite-base and passes through all sample points required to provide a smooth waveform. The numerical sequence {8, 9, 0, −1}/16 also has a finite-base impulse response.

To design a low pass filter according to such specifications as shown in FIG. 46, for example, the standard function X_{F1}, such as the one shown in (Equation 1), is input to the circuit; the standard function X_{F1} is determined by the coefficients {8, 9, 0, −1}/16 having finite-base impulse responses as described above. Specifically, 1024 numerical sequences are input which are calculated by varying the value of a sampling time (clock) tin (Equation 1) from 0/1024 to 1023/1024. FIG. 6 is a graph showing these 1024 numerical sequences. As shown in FIG. 6, inputting a standard function corresponds to, for example, inputting the waveform of a desired frequency characteristic determined by a numerical sequence having a finite-base impulse response.

After inputting the numerical sequence of the standard function X_{F1}, an interpolation function is determined on the basis of the standard function X_{F1} (step S12). The interpolation function to be determined interpolates the range between amplitude values “1” and “0” of the frequency amplitude characteristic. To determine the interpolation function, first, the ratio of the transition area to entire area of the frequency characteristic determined by the standard function X_{F1} (hereinafter referred to as a standard transition area ratio Rₜₛ) is determined. Here, the transition area refers to the area of the inclined part between a pass band and a stop band. With the first generation method, the transition area is considered to be the area between two representative points in the inclined part (for example, the range of the amplitude from −0.3 dB to −45 dB).

If the amplitude value of the pass band is set to “1”, the amplitude value of −0.3 dB in the standard function X_{F1} is 0.966051. The amplitude value of −45 dB is 0.005623. A calculation is made of the value for the standardization clock Td corresponding to these amplitude values in the first half of the frequency characteristic shown in FIG. 6. Then, Td_{-0.3}=0.107878, and Td₋₄₅=0.432775. Accordingly, the reference width Lₛ of transition area of the standard function X_{F1} is Lₛ=Td₋₄₅−Td_{-0.3}=0.324897. On the other hand, the number of standardization clocks in the first half of the frequency characteristic of the standard function X_{F1} is 0.5. Therefore, the standard transition area ratio Rₜₛ of the standard function X_{F1} is determined to be R_{ts=L}ₛ/0.5=0.649794.

Then, an interpolation function length Lᵢ is determined from the standard transition area ratio Rₜₛ. The term “interpolation function length Lᵢ” refers to the length (standardization clock count) of effective area of the interpolation function to be determined. The interpolation function length Lᵢ is determined from the clock width L_{d} of the transition area of the FIR filter to be designed and the standard transition area ratio Rₜₛ. If a low pass filter according to specifications shown in FIG. 46 is to be designed, the specification for the transition area width is 8.5 to 11.8 MHz. The clock width of a sampling frequency of 80 MHz is 1024. Accordingly, the clock corresponding to 8.5 MHz is T_{8.5M}=109, the clock corresponding to 11.8 MHz is T_{11.8M}=151, and the clock width L_{d} of the transition area to be designed is thus L_{d}=T_{11.8M}−T_{8.5M}=42. In this case, the interpolation function length Lᵢ is determined to be Lᵢ=L_{d}/Rₜₛ=64.576539.

To reduce the number of the taps in a low pass filter, it is desirable that the interpolation function length Lᵢ be an even integer larger than the calculated value. Thus, in this case, the interpolation function length Lᵢ is set to 66. An interpolation function I (LPF₁) with an interpolation function length Lᵢ of 66 clocks is determined as shown in the following partition equations (Equation 2-1) and (Equation 2-2).
I (LPF₁)=8/16+9/16*cos(2πt/66)−1/16*cos(6πt/66) (0/1024≦t≦65/1024) (Equation 2-1)
I (LPF₁)=0 (65/1024<t≦1023/1024) (Equation 2-2)

Specifically, the interpolation function I (LPF₁) determined is 1024 numerical sequences calculated by varying the value of the clock t in (Equations 2-1 and 2-2) from 0/1024 to 1023/1024. FIG. 7 is a graph showing these 1024 numerical sequences.

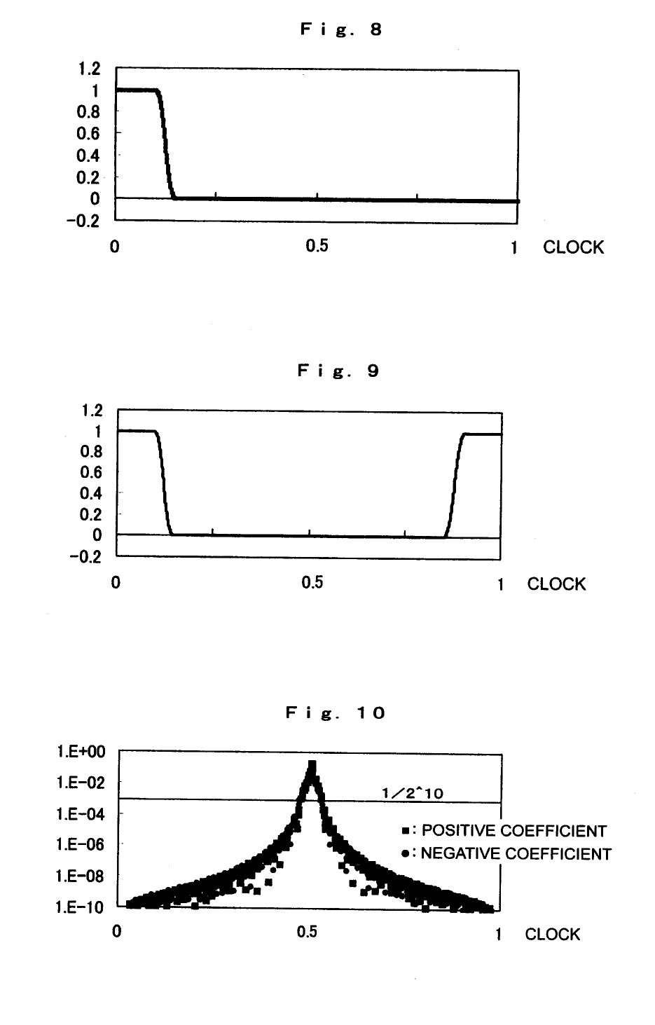

Once the interpolation function I (LPF₁) is thus determined, its frequency characteristic is shifted in the direction of the frequency axis (clock direction) so that the shifted interpolation function I (LPF,) joins the amplitude values “1” and “0” together (step S13). Specifically, 66 numerical sequences corresponding to the positions of the standardization clock t=0/1024 to 65/1024 determined by (Equation 2-1) are shifted to the positions of the standardization clock t=i/1024 to (i+65)/1024 (i is an integer). And all the numerical sequences at the positions of the standardization clock t=0/1024 to (i−1)/1024 are changed to “1”, And all the numerical sequences at the positions of the standardization clock t=(i+66)/1024 to 1023/1024 are changed to “0”. FIG. 8 is a graph showing the 1024 numerical sequences determined by thus shifting the interpolation function I (LPF₁).

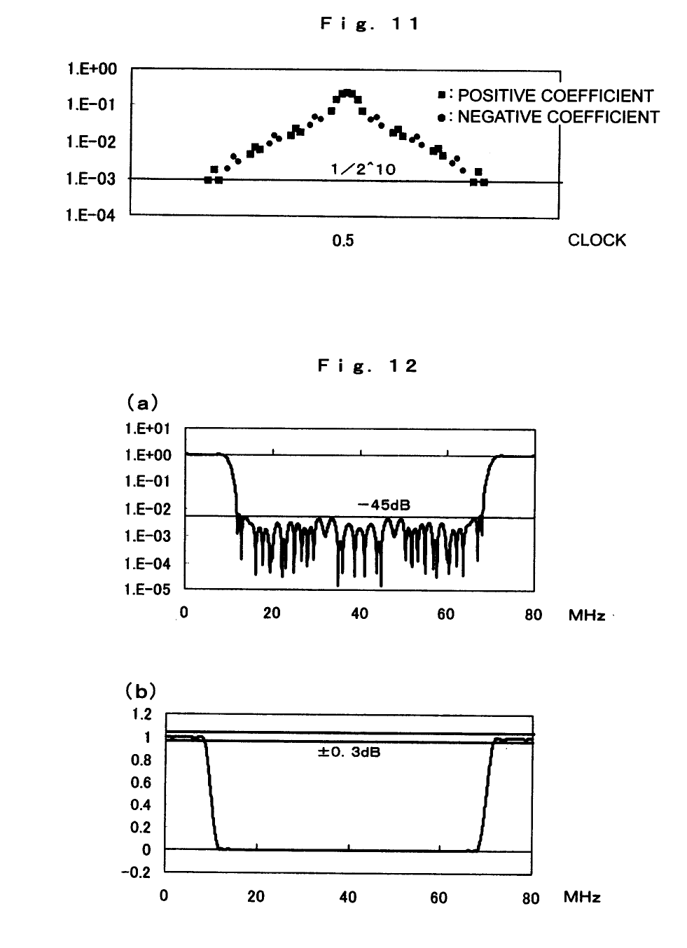

Then, the frequency characteristic shown in FIG. 8 is made laterally symmetric with respect to the position of the clock t=0.5 (step S14). Specifically, the arrangement of all the numerical sequences except the one corresponding to the standardization clock t=0/1024, that is, the numerical sequences corresponding to the clock t=1/1024 to 512/1024, is reversed. The reversed numerical sequences are copied to the positions of the standardization clock t=512/1024 to 1023/1024. The resulting laterally symmetric 1024 numerical sequences are determined to be the numerical sequences for the input frequency characteristic in step S1 in FIG. 1. FIG. 9 is a diagram showing the frequency characteristic obtained by making the frequency characteristic in FIG. 8 laterally symmetric.

The interpolation function shift amount i may be set at such a value as locates the amplitude value “0.5” of the interpolation function at positions on the frequency axis corresponding to its ⅛, 2/8, and ⅜. This simplifies the filter coefficients obtained by executing an inverse FFT on the numerical sequences for the input frequency characteristic in step S2 in FIG. 1. As a result, an FIR filter with a reduced number of taps can be designed.

<Second Generation Method>

Now, description will be given of a second method for determining the input frequency characteristic. FIG. 3 is a flowchart showing a procedure of calculating the input frequency characteristic in accordance with a second generation method, according to the present embodiment. Further, FIG. 4 illustrates the second generation method and shows the frequency amplitude characteristic of an interpolation function (low pass filter based on design specifications) generated by the second generation method.

In FIG. 3, first, a standard function is input to the circuit (step S21). The standard function to be input is of a finite-base similarly to that input in the first generation method, and is, for example, the standard function X_{F1} shown in (Equation 1).

After inputting the numerical sequence of the standard function X_{F1}, an interpolation function is determined on the basis of the standard function X_{F1} (step S22). The interpolation function to be determined is the one which interpolates the range between amplitude values “1” and “0” of the frequency amplitude characteristic, and which has been subjected to frequency shifting on the basis of the design specifications for the requested digital filter.

To determine the interpolation function which has been subjected to frequency shifting, first, the ratio of the transition area (based on the design specifications for the digital filter) of an interpolation function to be generated from the standard function X_{F1} to the transition area of the standard function X_{F1} (this ratio is hereinafter referred to as a requested transition area ratio Rₜᵣ). Unlike the transition area in the first generation method, the transition area in the second generation method is that area which the amplitude takes a value other than “1” and “0” in the frequency amplitude characteristic whose amplitude values are standardized between “1” and “0”. To determine the requested transition area ratio Rₜᵣ, information on two representative points (for example, the points at the amplitudes of −0.3 dB and −45 dB) in the transition area is used.

If the amplitude value of the pass band is set to “1”, the amplitude value of −0.3 dB in the standard function X_{F1} is 0.966051. The amplitude value of −45 dB is 0.005623. A calculation is made of the value for the standardization clock Td corresponding to these amplitude values in the first half of the frequency characteristic shown in FIG. 6. Then, Td_{-0.3}=0.107878, and Td₋₄₅=0.432775. Accordingly, the reference width Lₛ of transition area of the standard function X_{F1} is Lₛ=Td₋₄₅−Td_{-0.3}=0.324897. On the other hand, according to the filter specifications in FIG. 46, the reference width L_{rd} of transition area of the requested digital filter is L_{rd}=(11.8−8.5)/80=0.04125. Consequently, the requested transition area ratio Rₜᵣ of the requested digital filter (interpolation function) is determined to be Rₜᵣ=L_{rd}/Lₛ=0.126963.

Then, a calculation is made of the clock count Lₕₛ from the standardization clock t=0 for the requested digital filter to the start point t=k1 of the transition area (see FIG. 4). The clock count from the transition area start point k1 to the point k2 at −0.3 dB is defined as Tₖ₁₋ₖ₂. The standardization clock at the point k2 at −0.3 dB is defined as Tₖ₂. Then, the clock count Lₕₛ from the standardization clock t=0 to the transition area start point t=k1 is determined by Lₕₛ=Tₖ₂−Tₖ₁₋ₖ₂. Here, according to the filter specifications shown in FIG. 46, the frequency at −0.3 dB is 8.5 MHz. Accordingly, the standardization clock Tₖ₂ at the corresponding point k2 is Tₖ₂=8.5/80=0.10625. On the other hand, the clock count Tₖ₁₋ₖ₂ from the transition area start point k1 to the point k2 at −0.3 dB is determined by Td_{-0.3}*Rₜᵣ using the clock count Td_{-0.3} from the transition area start point (at t=0) in the standard function X_{F1} to the point at −0.3 dB, as well as the requested transition area ratio Rₜᵣ. As described above, Td_{-0.3}=0.107878, and Rₜᵣ=0.126963. Consequently, Tₖ₁₋ₖ₂=0.107878*0.126963=0.013697. Therefore, the clock count Lₕₛ up to the transition area start point k1 is determined to be Lₕₛ=0.10625−0.013697=0.092553.

Moreover, a calculation is made of the clock count Lₕₑ from the standardization clock t=0 for the requested digital filter to the end point t=k4 of the transition area. The clock count from the start point k1 to end point k4 of the transition area is defined as Tₖ₁₋ₖ₄. Then, the clock count Lₕₑ from the standardization clock t=0 to the transition area end point t=k4 is determined by Lₕₑ=Lₕₛ+Tₖ₁₋ₖ₄. Here, the clock count Tₖ₁₋ₖ₄ from the start point k1 to end point k4 of the transition area is determined by 0.5*Rₜᵣ using the clock count (=0.5) from the transition area start point (at t=0) to end point (at t=511/1024) in the standard function X_{F1}, as well as the requested transition area ratio Rₜᵣ. As described above, Rₜᵣ=0.126963, so that Tₖ₁₋ₖ₄=0.5*0.126963=0.063482. Therefore, the clock count Lₕₑ from the standardization clock t=0 to the transition area end point t=k4 is determined to be Lₕₑ=0.092553+0.063482=0.156035.

As a result, the interpolation function I (LPF₁) is determined as shown in the following partition equations (Equations 3-1, 3-2, and 3-3).
I (LPF₁)=1 (0/1024≦t<Lₕₛ) (Equation 3-1)
I (LPF₁)=8/16+9/16*cos((2π(t−Lₕₛ)/Rₜᵣ))−1/16*cos((6π(t−Lₕₛ)/Rₜᵣ)) (Lₕₛ<t≦Lₕₑ) (Equation 3-2)
I (LPF₁)=0 (Lₕₑ<t≦1023/1024) (Equation 3-3)

Specifically, the above interpolation function I (LPF₁) determined is 1024 numerical sequences calculated by varying the value of the clock t in (Equations 3) from 0/1024 to 1023/1024. A graph showing these 1024 numerical sequences is almost similar to that in FIG. 8 which has been obtained by the first generation method. However, the above first generation method rounds the calculated interpolation function length Lᵢ to an even integer larger than the calculated value. Further, the interpolation function determined by the rounded even integral interpolation function length Lᵢ has only been shifted in terms of clocks in the direction of the frequency axis. In contrast, the second generation method uses the resulting requested transition ratio Rₜᵣ as it is, that is, an accurate calculated value, to determine an interpolation function on the basis of equations including frequency shifts (start and end points of the transition area). This enables the position of the transition area to be more accurately realized on the basis of the design specifications shown in FIG. 46.

Then, the frequency characteristic shown in FIG. 8 is made laterally symmetric with respect to the position of the standardization clock t=0.5 (step S23). Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions corresponding to the clock t=512/1024 to 1023/1024. The resulting laterally symmetric 1024 numerical sequences are determined to be the numerical sequences for the input frequency characteristic in step S1 in FIG. 1.

FIG. 10 is a diagram showing the distribution of filter coefficients (which have not been subjected to the rounding process instep S4) for a low pass filter according to the specifications shown in FIG. 46, which have actually been determined, for example, to a calculation accuracy of 32 bits (y=32) according to the procedure shown in FIGS. 1 and 2. Here, the absolute values of the filter coefficients are taken so that the positive and negative coefficients are all shown in the same quadrant.

As shown in FIG. 10, the filter coefficients determined by the filter designing method according to the present embodiment have the largest value in a central part of the distribution (the position of the standardization clock t=511/1024). The filter coefficients have a very sharp distribution such that their values are larger in a local area close to the center and smaller in the other areas and such that there are very large differences between the filter coefficient values close to the center and the peripheral filter coefficient values. This also applies to the filter coefficients determined according to the procedure shown in FIGS. 1 and 3. Thus, even when filter coefficients with values smaller than a predetermined threshold are discarded by a rounding process, most of the major filter coefficients remain, which determine the frequency characteristic. Consequently, the frequency characteristic is not substantially affected. Further, the out-of-band attenuation amount of the frequency characteristic is limited by the number of bits of the filter coefficient. However, the frequency characteristic obtained by the filter designing method according to the present embodiment exhibits a very significant attenuation. Consequently, the desired attenuation amount can be obtained even with a slight decrease in the number of bits.

This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

Thus, the present embodiment can reduce the filter coefficients by performing a rounding operation utilizing coefficient values. Consequently, windowing, as utilized in the prior art, is not necessarily required. As described above, the standard function input in step S1 has a finite-base impulse response. Thus, the number of filter coefficients designed on the basis of this standard function is originally smaller than that in the prior art and may be used without rounding. However, to further reduce the taps, a rounding process is preferably executed to reduce the bits.

The present embodiment is markedly different from the conventional filter designing method in the above ability to perform a rounding operation utilizing coefficient values. That is, the conventional filter designing method does not provide a sufficiently sharp distribution for the filter coefficients to be determined. Consequently, a rounding process with filter coefficient values often discards the major filter coefficients, which determine the frequency characteristic. Further, it is also difficult to obtain a frequency characteristic exhibiting a very large out-of-band attenuation amount. This prevents the required out-of-band attenuation amount from being obtained when the bits of the filter coefficient are reduced. Thus, the conventional technique cannot execute a rounding process for reducing the bits and is thus forced to reduce the filter coefficients by means of windowing. This results in a discretization error in the frequency characteristic, making it very difficult to obtain the desired frequency characteristic.

In contrast, the present embodiment can design an FIR filter without windowing, preventing a possible discretization error in the frequency characteristic. This enables the cutoff characteristic to be very significantly improved, providing an excellent filter characteristic with a rectilinear phase characteristic. In other words, an appropriate frequency characteristic can be offered which exhibits a pass band characteristic with reduced ripple and a uniform attenuation characteristic.

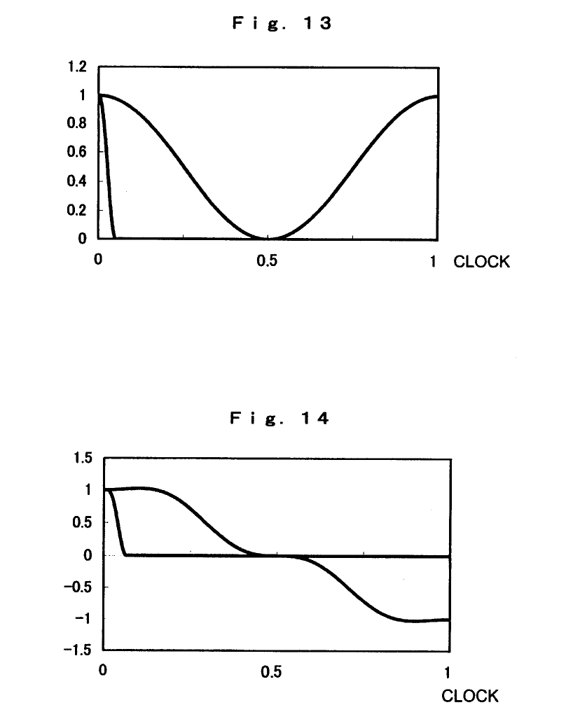

FIG. 11 is a distribution diagram showing filter coefficients obtained by setting x=10, that is, multiplying 32-bit filter coefficients determined by an inverse FFT, by a factor of 2¹⁰, dropping the resulting decimal fractions, and multiplying the result by a factor of 1/2¹⁰. In FIG. 11, the vicinity of the center of the distribution, corresponding to t=511/1024, is enlarged. Further, FIG. 12 is a diagram showing the frequency amplitude characteristic of an FIR low pass filter implemented using the filter coefficients shown in FIG. 11. FIG. 12(a) shows gain on a logarithmic scale. FIG. 12(b) shows gain on a straight scale.

As shown in FIG. 11, the filter designing method according to the present embodiment finally determines only 43 filter coefficients. The present embodiment does not execute windowing for filter designing. As clearly seen in FIG. 12, this sharply reduces the ripple in the flat part of the frequency amplitude characteristic; the amount of ripple sufficiently falls within the range of ±0.3 dB. Further, after a rounding process, the out-of-band attenuation amount is about 45 dB. Thus, even only the 43 taps meet the specifications shown in FIG. 46.

In the description of this example, the standard function X_{F1}, such as the one shown in (Equation 1), is used to design a low pass filter. However, (Equation 1) is only illustrative. For example, a standard function X_{F2} or X_{F3} expressed by (Equation 4) or (Equation 5), respectively, may be used.
X_{F2}=1/2+cos(2πt) (Equation 4)
X_{F3}=cos(πt)+1/8*cos(3πt)−1/8*cos(5πt) (Equation 5)

Here, the coefficients {1/2, 1} of the items of (Equation 4) constitute a numerical sequence corresponding to one of the halves into which the numerical sequence {1, 2, 1}/2 is divided at the center. Further, the coefficients {1, 1/8, −1/8} of the items of (Equation 5) constitute a numerical sequence corresponding to one of the halves into which the numerical sequence {−1, 1, 8, 8, 1, −1}/8 for a basic low pass filter L4a3 described in Japanese Patent Application No. 2003-56265 is divided at the center.

Japanese Patent Application No. 2003-56265 shows several numerical sequences for a low pass filter which are different from the numerical sequences corresponding to the coefficients of the items of (Equation 1), (Equation 4), and (Equation 5). The functions corresponding to these numerical sequences may each be used as the standard function according to the present embodiment.

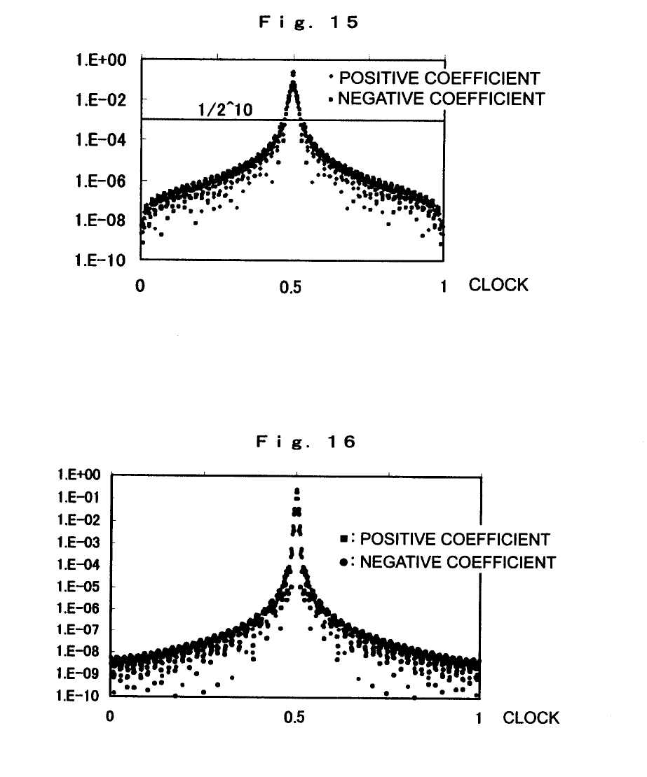

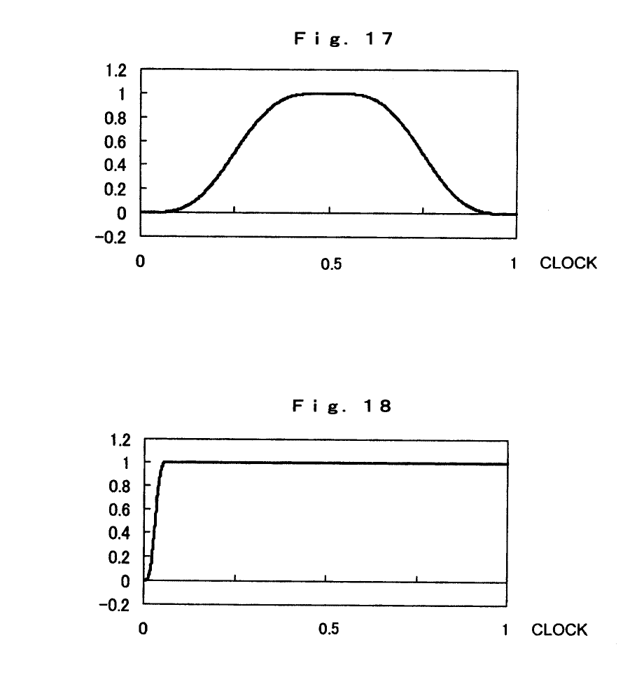

FIG. 13 is a graph of the standard function X_{F2}, expressed by (Equation 4), and the interpolation function I (LPF₂) that is determined from the standard function X_{F2}. FIG. 14 is a graph of the standard function X_{F3}, expressed by (Equation 5), and the interpolation function I (LPF₃) that is determined from the standard function X_{F3}. Further, FIG. 15 is a diagram showing the distribution of filter coefficients (which have not been subjected to a rounding process) which have actually been determined, for example, to a calculation accuracy of 32 bits according to the procedure shown in FIGS. 1 and 2, using the interpolation function I (LPF₂). FIG. 16 is a diagram showing the distribution of filter coefficients (which have not been subjected to a rounding process) which have actually been determined, for example, to a calculation accuracy of 32 bits according to the procedure shown in FIGS. 1 and 2, using the interpolation function I (LPF₃). Also in FIGS. 15 and 16, the absolute values of the filter coefficients are taken so that the positive and negative coefficients are all shown in the same quadrant.

As shown in FIGS. 15 and 16, the standard function X_{F2} or X_{F3}, shown in (Equation 4) or (Equation 5), respectively, also allow the filter coefficients determined by the filter designing method according to the present embodiment to exhibit the largest value in the center of the distribution (position of the clock t=511/1024). The filter coefficients have a very sharp distribution such that their values are larger in a local area close to the center and smaller in the other areas and such that there are very large differences between the filter coefficient values close to the center and the peripheral filter coefficient values. This also applies to the filter coefficients determined according to the procedure shown in FIGS. 1 and 3.

Thus, even when filter coefficients with values smaller than a predetermined threshold are discarded by a rounding process, most of the major filter coefficients remain, which determine the frequency characteristic. Consequently, the frequency characteristic is not substantially affected. This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

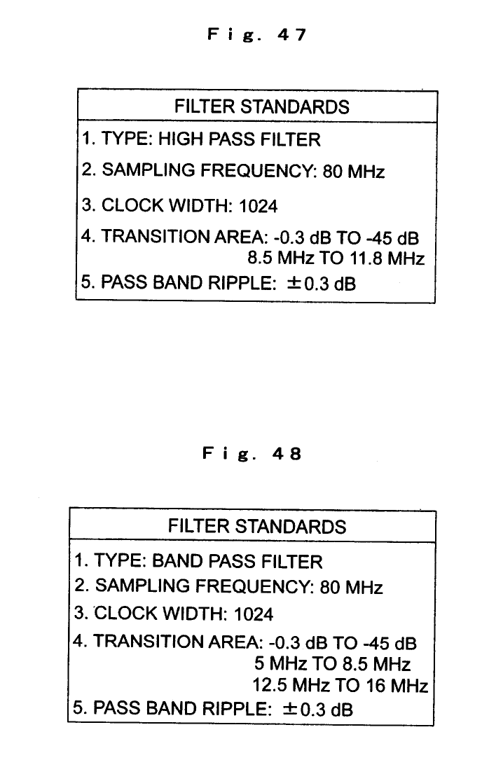

Now, description will be given of an example in which a high pass filter according to such specifications as shown in FIG. 47 is to be designed.

<First Generation Method>

To generate an input frequency characteristic according to the above first generation method, first, the standard function X_{F4}, such as the one shown in (Equation 6), is input to the circuit. The input standard function X_{F4} is of a finite-base such that its impulse response has a finite value other than “0” in a local area and a value of “0” in all the other areas.
X_{F4}=8/16−9/16*cos(2πt)+1/16*cos(6πt) (Equation 6)

Here, the function shown in (Equation 6) is obtained by standardization using a maximum amplitude value of 1 and a maximum frequency value of 1. The coefficients {8/16, −9/16, 0, 1/16} (“0” is the coefficient of the item cos (4πt)) of the items of (Equation 6) constitute a numerical sequence corresponding to one of the halves into which the filter coefficients {1, 0, −9, 16, −9, 0, 1}/16 of the high pass filter described in Japanese Patent Application No. 2003-56265 are divided at the center. As described in Japanese Patent Application No. 2003-56265 in detail, the impulse response from a high pass filter having the numerical sequence {1, 0, −9, 16, −9, 0, 1}/16 as filter coefficients is of a finite-base and passes through all sample points required to provide a smooth waveform. The numerical sequence {8, −9, 0, 1}/16 also has a finite-base impulse response.

To design a high pass filter according to such specifications as shown in FIG. 47, for example, the standard function X_{F4}, such as shown in (Equation 6), is input to the circuit; the standard function X_{F4} is determined by the coefficients {8, −9, 0, 1}/16 having a finite-base impulse response as described above. Specifically, 1024 numerical sequences are input which are calculated by varying the value of the clock t in (Equation 6) from 0/1024 to 1023/1024. FIG. 17 is a graph showing these 1024 numerical sequences.

After inputting the numerical sequence of the standard function X_{F4}, an interpolation function is determined on the basis of the standard function X_{F4}. To determine the interpolation function, first, the standard transition area ratio Rₜₛ of the frequency characteristic determined by the standard function X_{F4} is determined.

If the amplitude value of the pass band is set to “1”, the amplitude value of −0.3 dB in the standard function X_{F4} is 0.966051. The amplitude value of −45 dB is 0.005623. A calculation is made of the value for the standardization clock Tu corresponding to these amplitude values in the first half of the frequency characteristic shown in FIG. 17. Then, Tu_{-0.3}=0.392122, and Tu₋₄₅=0.067225. Accordingly, the reference width Lₛ of transition area of the standard function X_{F4} is Lₛ=Tu_{-0.3}−Tu₋₄₅=0.324897. On the other hand, the number of standardization clocks in the first half of the frequency characteristic of the standard function X_{F4} is 0.5. Therefore, the standard transition area ratio Rₜₛ of the standard function X_{F4} is determined to be Rₜₛ=Lₛ/0.5=0.649794.

Then, an interpolation function length Lᵢ is determined from the standard transition area ratio Rₜₛ. If a high pass filter according to the specifications shown in FIG. 47 is to be designed, the specification for the transition area width is 8.5 to 11.8 MHz. The clock width of a sampling frequency of 80 MHz is 1024. Accordingly, the clock corresponding to 8.5 MHz is T_{8.5M}=109, and the clock corresponding to 11.8 MHz is T_{11.8M}=151. The clock width L_{d} of the transition area to be designed is thus L_{d}=T_{11.8M}−T_{8.5M}=42. In this case, the interpolation function length Lᵢ is determined to be Lᵢ=L_{d}/Rₜₛ=64.576539.

To reduce the number of the taps in a high pass filter, it is desirable that the interpolation function length Lᵢ be an even integer larger than the calculated value. Thus, in this case, the interpolation function length Lᵢ is set to 66. An interpolation function I (HPF) with an interpolation function length Lᵢ of 66 clocks is determined as shown in the following partition equations (Equation 7-1) and (Equation 7-2).
I (HPF)=8/16−9/16*cos(2πt/66)+1/16*cos(6πt/66) (0/1024≦t≦65/1024) (Equation 7-1)
I (HPF)=1 (65/1024<t≦1023/1024) (Equation 7-2)

Specifically, the interpolation function I (HPF) determined is 1024 numerical sequences calculated by varying the value of the clock t in (Equations 7-1 and 7-2) from 0/1024 to 1023/1024. FIG. 18 is a graph showing these 1024 numerical sequences.

Once the interpolation function I (HPF) is thus determined, its frequency characteristic is shifted in the direction of the frequency axis (clock direction) so that the shifted interpolation function I (HPF) joins the amplitude values “1” and “0” together. Specifically, 66 numerical sequences corresponding to the positions of the standardization clock t=0/1024 to 65/1024 determined by (Equation 7-1) are shifted to the positions of the standardization clock t=i/1024 to (i+65)/1024 (i is an integer). And all the numerical sequences at the positions of the standardization clock t=0/1024 to (i−1)/1024 are changed to “0”, and all the numerical sequences at the positions of the standardization clock t=(i+66)/1024 to 1023/1024 are changed to “1”. FIG. 19 is a graph showing the 1024 numerical sequences determined by thus shifting the interpolation function I (HPF).

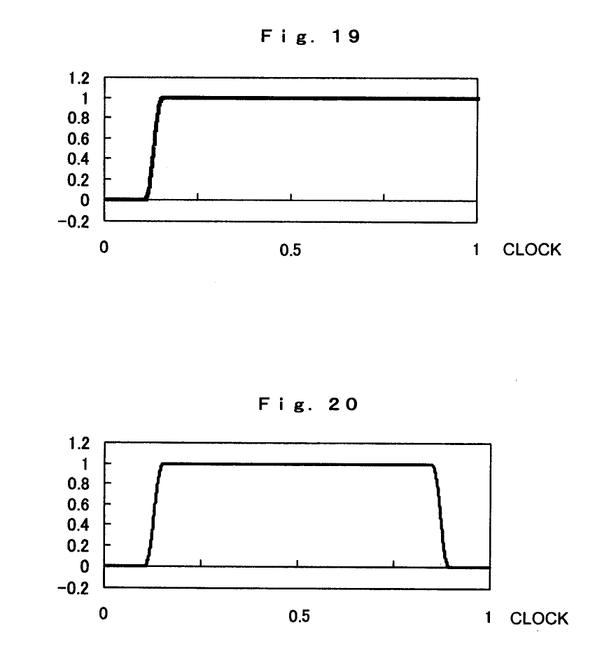

Then, the frequency characteristic shown in FIG. 19 is made laterally symmetric with respect to the position of the clock t=0.5. Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions of the standardization clock t=512/1024 to 1023/1024. The resulting laterally symmetric 1024 numerical sequences are determined to be the numerical sequences for the input frequency characteristic in step S1 in FIG. 1. FIG. 20 is a diagram showing the frequency characteristic obtained by making the frequency characteristic in FIG. 19 laterally symmetric.

The interpolation function shift amount i in this case may be also set at such a value as locates the amplitude value “0.5” of the interpolation function at positions on the frequency axis corresponding to its ⅛, 2/8, and ⅜. This simplifies the filter coefficients obtained by subjecting the numerical sequences for the input frequency characteristic to an inverse FFT in step S2 in FIG. 1. As a result, an FIR filter with a reduced number of taps can be designed.

<Second Generation Method>

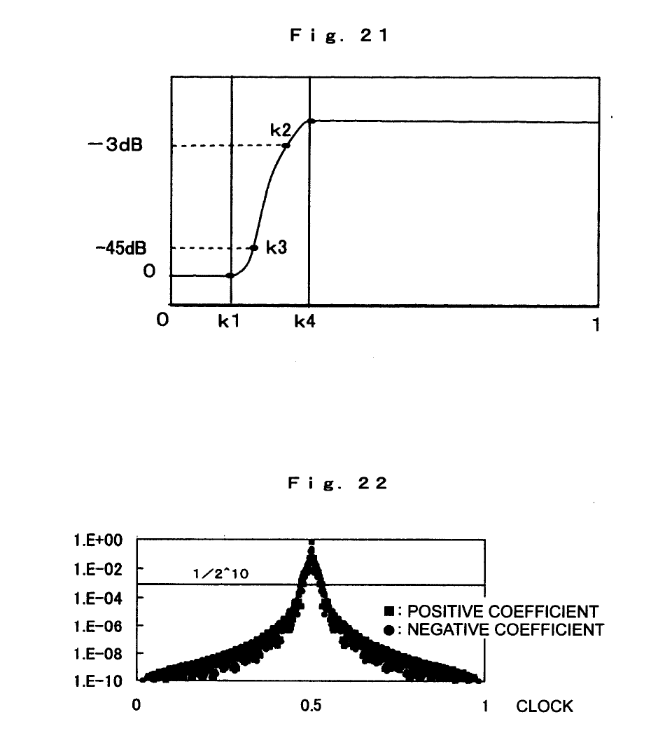

FIG. 21 illustrates a second generation method and shows the frequency amplitude characteristic of an interpolation function (high pass filter based on design specifications) generated by the second generation method.

To generate an input frequency characteristic according to the second generation method, first, such a standard function X_{F4} as shown in (Equation 6) is input to the circuit. After inputting the numerical sequence of the standard function X_{F4}, an interpolation function containing frequency shifts is determined on the basis of the standard function X_{F4}.

To determine an interpolation function subjected to frequency shifting, first, the requested transition area ratio Rₜᵣ of the interpolation function corresponding to the standard function X_{F4} is determined. To determine the requested transition area ratio Rₜᵣ, information on two representative points (for example, the points at the amplitudes of −0.3 dB and −45 dB) in the transition area is used.

If the amplitude value of the pass band is set to “1”, the amplitude value of −0.3 dB in the standard function X_{F4} is 0.966051. The amplitude value of −45 dB is 0.005623. A calculation is made of the value for the standardization clock Tu corresponding to these amplitude values in the first half of the frequency characteristic shown in FIG. 17. Then, Tu_{-0.3}=0.392122, and Tu₋₄₅=0.067225. Accordingly, the reference width Lₛ of transition area of the standard function X_{F4} is Lₛ=Tu_{-0.3}−Tu₋₄₅=0.324897. On the other hand, according to the filter specifications in FIG. 47, the reference width L_{rd} of transition area of the requested digital filter is L_{rd}=(11.8−8.5)/80=0.04125. Consequently, the requested transition area ratio Rₜᵣ of the requested digital filter (interpolation function) is determined to be Rₜᵣ=L_{rd}/Lₛ=0.126963.

Then, a calculation is made of the clock count Lₕₛ from the standardization clock t=0 for the requested digital filter to the start point t=k1 of the transition area (see FIG. 21). The clock count from the transition area start point k1 to the point k3 at −45 dB is defined as Tₖ₁₋ₖ₃. The standardization clock at the point k3 at −45 dB is defined as Tₖ₃. Then, the clock count Lₕₛ from the standardization clock t=0 to the transition area start point t=k1 is determined by Lₕₛ=Tₖ₃−Tₖ₁₋ₖ₃. Here, according to the filter specifications shown in FIG. 47, the frequency at −45 dB is 8.5 MHz. Accordingly, the standardization clock Tₖ₃ at the corresponding point k3 is Tₖ₃=8.5/80 =0.10625. On the other hand, the clock count Tₖ₁₋ₖ₃ from the transition area start point k1 to the point k3 at −45 dB is determined by Tu₋₄₅*Rₜᵣ using the clock count Tu₋₄₅ from the transition area start point (at t=0) in the standard function X_{F4} to the point at −45 dB, as well as the requested transition area ratio Rₜᵣ. As described above, Tu₋₄₅=0.067225, and Rₜᵣ=0.126963. Consequently, Tₖ₁₋ₖ₃=0.067225*0.126963=0.008535. Therefore, the clock count Lₕₛ up to the transition area start point k1 is determined to be Lₕₛ=0.10625−0.008535=0.097715.

Moreover, a calculation is made of the clock count Lₕₑ from the standardization clock t=0 for the requested digital filter to the end point t=k4 of the transition area. The clock count from the start point k1 to end point k4 of the transition area is defined as Tₖ₁₋ₖ₄. Then, the clock count Lₕₑ from the standardization clock t=0 to the transition area end point t=k4 is determined by Lₕₑ=Lₕₛ+Tₖ₁₋ₖ₄. Here, the clock count Tₖ₁₋ₖ₄ from the start point k1 of the transition area to the end point k4 is determined by 0.5*Rₜᵣ using the clock count (=0.5) from the transition area start point (at t=0) to end point (at t=511/1024) in the standard function X_{F4}, as well as the requested transition area ratio Rₜᵣ. As described above, Rₜᵣ=0.126963, so that Tₖ₁₋ₖ₄=0.5*0.126963=0.063482. Therefore, the clock count Lₕₑ from the standardization clock t=0 to the transition area end point t=k4 is determined to be Lₕₑ=0.097715+0.063482=0.161197.

As a result, the interpolation function I (HPF) is determined as shown in the following partition equations (Equations 8-1, 8-2, and 8-3).

$$\begin{matrix}I ( HPF ) = 0 \\ ( 0 / 1024 \leq t < {L}_{hs} ) & ( Equation 8 \text{-} 1 ) \\ \begin{matrix}I ( HPF ) = 8 / 16 - 9 / 16 * cos ( ( 2 π ( t - {L}_{hs} ) / {R}_{tr} ) ) + \\ 1 / 16 * cos ( ( 6 π ( t - {L}_{hs} ) / {R}_{tr} ) )\end{matrix} \\ ( {L}_{hs} \leq t \leq {L}_{he} ) & ( Equation 8 \text{-} 2 ) \\ I ( HPF ) = 1 \\ ( {L}_{he} < t \leq 1023 / 1024 ) & ( Equation 8 \text{-} 3 )\end{matrix}$$

Specifically, the above interpolation function I (HPF) determined is 1024 numerical sequences calculated by varying the value of the clock t in (Equations 8) from 0/1024 to 1023/1024. A graph showing these 1024 numerical sequences is almost similar to that in FIG. 19 which has been obtained by the first generation method. However, the resulting frequency characteristic enables the position of the transition area based on the design specifications shown in FIG. 47 to be realized more accurately than that determined by the first generation method.

Then, the frequency characteristic shown in FIG. 19 is made laterally symmetric with respect to the position of the standardization clock t=0.5. Specifically, the arrangement of all the numerical sequences except the one corresponding to the standardization clock t=0/1024, that is, the numerical sequences corresponding to the standardization clock t=1/1024 to 511/1024, is reversed. The reversed numerical sequences are copied to the positions corresponding to the clock t=512/1024 to 1023/1024. The resulting laterally symmetric 1024 numerical sequences are determined to be the numerical sequences for the input frequency characteristic in step S1 in FIG. 1.

FIG. 22 is a diagram showing the distribution of filter coefficients (which have not been subjected to a rounding process) for a high pass filter according to the specifications shown in FIG. 47, which have actually been determined, for example, to a calculation accuracy of 32 bits according to the procedure shown in FIGS. 1 and 2. Here, the absolute values of the filter coefficients are taken so that the positive and negative coefficients are all shown in the same quadrant.

As shown in FIG. 22, the filter coefficients determined by the filter designing method according to the present embodiment have the largest value in a central part of the distribution (the position of the standardization clock t=511/1024). The filter coefficients have a very sharp distribution such that their values are larger in a local area close to the center and smaller in the other areas and such that there are very large differences between the filter coefficient values close to the center and the peripheral filter coefficient values. This also applies to the filter coefficients determined according to the procedure shown in FIGS. 1 and 3.

Thus, even when filter coefficients with values smaller than a predetermined threshold are discarded by a rounding process, most of the major filter coefficients remain, which determine the frequency characteristic. Consequently, the frequency characteristic is not substantially affected. Further, the frequency characteristic obtained by the filter designing method according to the present embodiment exhibits a very significant attenuation. Consequently, the desired attenuation amount can be obtained even with a slight decrease in the number of bits.

This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

Thus, the present embodiment can reduce the filter coefficients by performing a rounding operation utilizing coefficient values. Consequently, windowing, as utilized in the prior art, is not necessarily required. As described above, the standard function input in step S1 has a finite-base impulse response. Thus, the number of filter coefficients designed on the basis of this standard function is originally smaller than that in the prior art. Accordingly, the standard function can be used as it is without the need for a rounding process. However, to further simplify the circuit, a rounding process is preferably executed to reduce the bits.

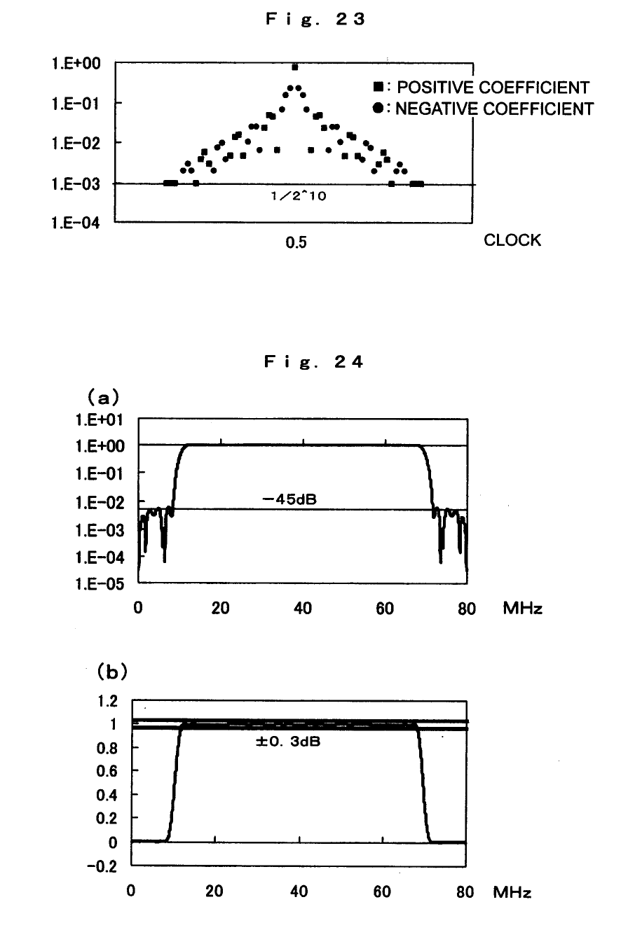

FIG. 23 is a distribution diagram showing filter coefficients obtained by setting x=10, that is, multiplying 32-bit filter coefficients determined by an inverse FFT, by a factor of 2¹⁰, dropping the resulting decimal fractions, and multiplying the result by a factor of 1/2¹⁰. In FIG. 23, the vicinity of center of the distribution, corresponding to t=512/1024, is enlarged. Further, FIG. 24 is a diagram showing the frequency amplitude characteristic of an FIR high pass filter implemented using the filter coefficients shown in FIG. 23. FIG. 24(a) shows gain on a logarithmic scale. FIG. 24(b) shows gain on a straight scale.

As shown in FIG. 23, the filter designing method according to the present embodiment finally determines only 59 filter coefficients. The present embodiment does not execute windowing for filter designing. As clearly seen in FIG. 24, this sharply reduces the ripple in the flat part of the frequency amplitude characteristic; the amount of ripple sufficiently falls within the range of ±0.3 dB. Further, after a rounding process, the out-of-band attenuation amount is about 45 dB. Thus, even only the 59 taps meet the specifications shown in FIG. 47.

In the description of this example, such a standard function X_{F4} as shown in (Equation 6) is used to design a high pass filter. However, the clock may be shifted by 0.5 using the standard function X_{F1} for a low pass filter. Further, (Equation 6) is only illustrative. For example, a standard function X_{F5} or X_{F6} expressed by (Equation 9) or (Equation 10), respectively, may be used.
X_{F5}=−1/2+sin(2πt) (Equation 9)
X_{F6}=cos(πt)−1/8*cos(3πt)−1/8*cos(5πt) (Equation 10)

Here, the coefficients {−1/2, 1} of the items of (Equation 9) constitute a numerical sequence corresponding to one of the halves into which the numerical sequence {−1, 2, −1}/2 is divided at the center. Further, the coefficients {1, −1/8, −1/8} of the items of (Equation 10) constitute a numerical sequence corresponding to one of the halves into which the numerical sequence {1, 1, −8, 8, −1, −1}/8 for a basic high pass filter H4a3 described in Japanese Patent Application No. 2003-56265 is divided at the center.

Japanese Patent Application No. 2003-56265 shows several numerical sequences for a high pass filter which are different from the numerical sequences corresponding to the coefficients of the items of (Equation 6), (Equation 9), and (Equation 10). The functions corresponding to these numerical sequences may each be used as the standard function according to the present embodiment.

Although not particularly shown in the drawings, not only the standard function in (Equation 6) but also such a standard function as shown in (Equation 9) or (Equation 10) allows the filter coefficients determined by the filter designing method according to the present invention to exhibit the largest value in the center of the distribution (position of the clock t=512/1024). The filter coefficients have a very sharp distribution such that their values are larger in a local area close to the center and smaller in the other areas and such that there are very large differences between the filter coefficient values close to the center and the peripheral filter coefficient values.

Thus, even when filter coefficients with values smaller than a predetermined threshold are discarded by a rounding process, most of the major filter coefficients remain, which determine the frequency characteristic. Consequently, the frequency characteristic is not substantially affected. This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

Now, description will be given of an example in which a band pass filter according to such specifications as shown in FIG. 48 is to be designed.

<First Generation Method>

To generate an input frequency characteristic according to a first generation method, first, for example, the standard function X_{F1} for a low pass filter, shown in (Equation 1), and the standard function X_{F4} for a high pass filter, shown in (Equation 6) (see FIGS. 6 and 17) are input.

After inputting the standard functions X_{F1} and X_{F4}, an interpolation function is determined on the basis of the standard functions X_{F1} and X_{F4}. First, standard transition area ratios R_{tsL} and R_{tsH} of an identified frequency characteristic are determined from the standard functions X_{F1} and X_{F4}.

If the amplitude value of the pass band is set to “1”, the amplitude value of −0.3 dB is 0.966051. The amplitude value of −45 dB is 0.005623. For example, a calculation is made of the value for the standardization clock Td corresponding to these amplitude values in the first half of the frequency characteristic shown in FIG. 6. Then, Td_{-0.3}=0.107878, and Td₋₄₅=0.432775. Accordingly, the reference width L_{sL} of transition area of the standard function X_{F1} is L_{sL}=Td₋₄₅−Td_{-0.3}=0.324897. Further, a calculation is made of the value for the standardization clock Tu corresponding to these amplitude values in the first half of the frequency characteristic shown in FIG. 17. Then, Tu_{-0.3}=0.392122, and Tu₋₄₅=0.067225. Accordingly, the reference width L_{sH} of transition area of the standard function X_{F4} is L_{sH}=Tu_{-0.3}−Tu₋₄₅=0.324897. On the other hand, the number of standardization clocks in the first half of the frequency characteristic of the standard functions X_{F1} and X_{F4} is 0.5. Therefore, the standard transition area ratios R_{tsL} and R_{tsH} of the standard functions X_{F1} and X_{F4} are determined to be R_{tsL}=L_{sL}/0.5=0.649794 and R_{tsH}=L_{sH}/0.5=0.649794.

Then, interpolation function lengths L_{iL} and L_{iH} of the low pass filter and the high pass filter are determined from the standard transition area ratios R_{tsL} and R_{tsH}, respectively. If a band pass filter according to specifications shown in FIG. 48 is to be designed, the specification for the transition area width is 5 to 8.5 MHz and 12.5 to 16 MHz. The clock width of a sampling frequency of 80 MHz is 1024. Accordingly, the clock corresponding to 12.5 MHz for the transition area of the low pass filter is T_{12.5M}=160. The clock corresponding to 16 MHz is T_{16M}=205. The clock width of the transition area to be designed is thus L_{dL}=T_{16M}−T_{12.5M}=45. In this case, the interpolation function length L_{iL} of the low pass filter is determined to be L_{iL}=L_{dL}/R_{tsL}=69.189149.

For the transition area of the high pass filter, the clock corresponding to 5 MHz is T_{5M}=64 and the clock corresponding to 8.5 MHz is T_{8.5M}=109. The clock width of the transition area to be designed is thus L_{dH}=T_{8.5M}−T_{5M}=45. Therefore, the interpolation function length L_{iH} of the high pass filter is also determined to be L_{iH}=L_{dH}/R_{tsH}=69.189149.

To reduce the number of the taps in a band pass filter, it is desirable that the interpolation function lengths L_{iL} and L_{iH} be even integers larger than the calculated values. Thus, in this case, the interpolation function lengths L_{iL} and L_{iH} are both set to 70.

An interpolation function I (LPF_{B}) for the low pass filter which has an interpolation function length L_{iL} of 70 clocks is determined as shown in the following partition equations (Equation 11-1) and (Equation 11-2).
I (LPF_{B})=8/16+9/16*cos(2πt/70)−1/16*cos(6πt/70) (0/10245≦t≦69/1024) (Equation 11-1)
I (LPF_{B})=0 (69/1024<t≦1023/1024) (Equation 11-2)

An interpolation function I (HPF_{B}) for the high pass filter which has an interpolation length L_{iH} of 70 clocks is determined as shown in the following partition equations (Equation 12-1) and (Equation 12-2).
I (HPF_{B})=8/16−9/16*cos(2πt/70)+1/16*cos(6πt/70) (0/1024≦t≦69/1024) (Equation 12-1)
I (HPF_{B})=1 (69/1024<t≦1023/1024) (Equation 12-2)

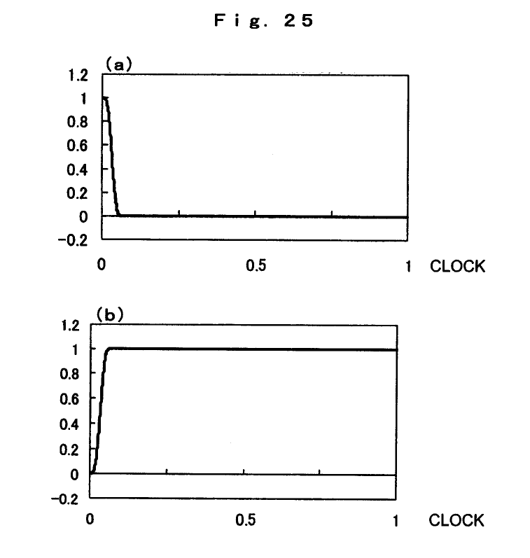

FIG. 25 is a diagram showing the interpolation function I (LPF_{B}) for the low pass filter, expressed by (Equations 11-1, 11-2), and the interpolation function I (HPF_{B}) for the high pass filter, expressed by (Equations 12-1, 12-2). FIG. 25(a) shows the interpolation function I (LPF_{B}) for the low pass filter. FIG. 25(b) shows the interpolation function I (HPF_{B}) for the high pass filter.

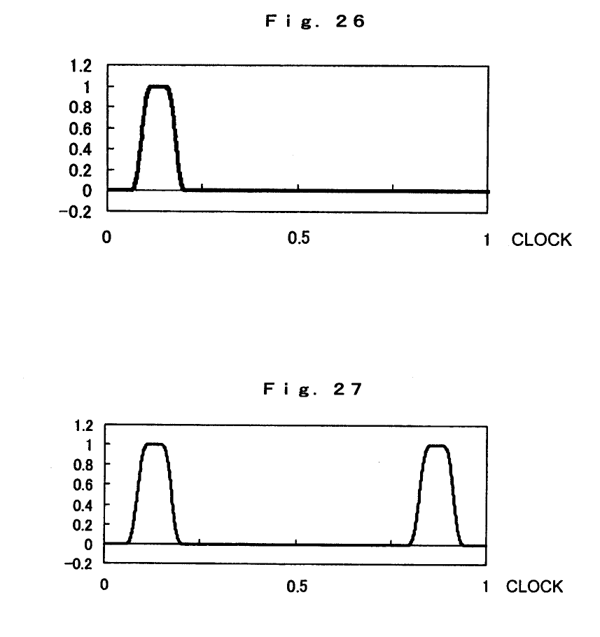

Once the interpolation functions I (LPF_{B}) and I (HPF_{B}) for the low and high pass filters are thus determined, their frequency characteristics are shifted in the direction of the frequency axis (clock direction) so that the shifted interpolation functions I (LPF_{B}) and I (HPF_{B}) join the amplitude values “1” and “0” together. Specifically, 70 numerical sequences corresponding to the positions of the clock t=0/1024 to 69/1024 determined by (Equation 11-1) are shifted to the positions of the clock t=i/1024 to (i+69)/1024 (i is an integer). Further, 70 numerical sequences corresponding to the positions of the clock t=0/1024 to 69/1024 determined by (Equation 12-1) are shifted to the positions of the clock t=j/1024 to (j+69)/1024 (i>j; j is an integer). Then, all the numerical sequences at the positions of the clock t=1/1024 to (j−1)/1024 and (i+70)/1024 to 1023/1024 are changed to “0”. And all the numerical sequences at the positions of the clock t=(j+70)/1024 to (i−1)/1024 are changed to “1”. FIG. 26 is a graph showing the 1024 numerical sequences determined by thus shifting the interpolation functions I (LPF_{B}) and I (HPF_{B}).

Then, the frequency characteristic shown in FIG. 26 is made laterally symmetric with respect to the position of the clock t=0.5. Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions of the clock t=512/1024 to 1023/1024. The resulting laterally symmetric 1024 numerical sequences are determined to be the numerical sequences for the input frequency characteristic in step S1 in FIG 1. FIG. 27 is a diagram showing the frequency characteristic obtained by making the frequency characteristic in FIG. 26 laterally symmetric.

The interpolation function shift amounts i and j in this case may be set at such values as locate the amplitude value “0.5” of the interpolation function at positions on the frequency axis corresponding to its ⅛, 2/8, and ⅜. This simplifies the filter coefficients obtained by executing an inverse FFT on the numerical sequences for the input frequency characteristic in step S2 in FIG. 1. As a result, an FIR filter with a reduced number of taps can be designed.

<Second Generation Method>

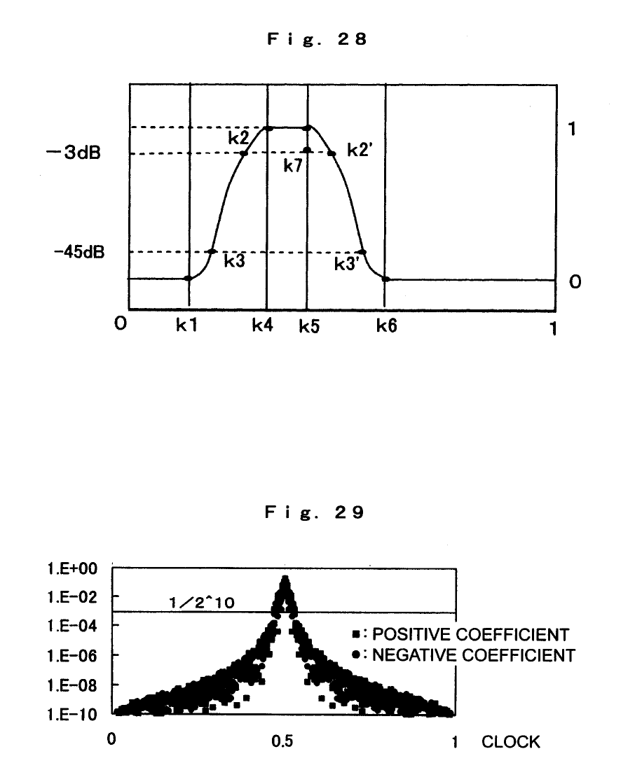

FIG. 28 illustrates a second generation method and shows the frequency amplitude characteristic of an interpolation function (band pass filter based on design specifications) generated by the second generation method.

To generate an input frequency characteristic according to the second generation method, first, the standard functions X_{F1} and X_{F4}, such as those shown in (Equation 1) and (Equation 6), are input to the circuit. After inputting the numerical sequences of the standard functions X_{F1} and X_{F4}, an interpolation function containing frequency shifts is determined on the basis of the standard functions X_{F1} and X_{F4}.

To determine an interpolation function subjected to frequency shifting, first, the requested transition area ratios R_{trL} and R_{trH} of the interpolation function corresponding to the standard functions X_{F1} and X_{F4} are determined. To determine the requested transition area ratio Rₜᵣ, information on two representative points (for example, the points at the amplitudes of −0.3 dB and −45 dB) in the transition area is used.

If the amplitude value of the pass band is set to “1”, the amplitude value of −0.3 dB in the standard functions X_{F1} and X_{F4} is 0.966051. The amplitude value of −45 dB is 0.005623. A calculation is made of the value for the standardization clock corresponding to these amplitude values in the first half of the frequency characteristic shown in each of FIGS. 6 and 17. Then, Td_{-0.3}=0.107878, and Td₋₄₅=0.432775, and Tu_{-0.3}=0.392122, and Tu₋₄₅=0.067225. Accordingly, the reference widths L_{sd} and Lₛᵤ of transition areas of the standard functions X_{F1} and X_{F4} are L_{sd}=Td₋₄₅−Td_{-0.3}=0.324897, and Lₛᵤ=Tu_{-0.3}−Tu₋₄₅=0.324897. On the other hand, according to the filter specifications in FIG. 48, the reference widths L_{rdL} and L_{rdH} of transition areas of the requested digital filters is L_{rdH}=(11.8−8.5)/80=0.04125, and L_{rdL}=(16−12.5)/80=0.04375. Consequently, the requested transition area ratios R_{trL} and R_{trH} of the requested digital filter (interpolation function) are determined to be R_{trL}=L_{rdL}/L_{sd}=0.134658, and R_{trH}=L_{rdH}/Lₛᵤ=0.126963.

Then, a calculation is made of the clock count L_{hsH} from the standardization clock t=0 for the requested digital filter to the start point t=k1 of the transition area (see FIG. 28). The clock count from the transition area start point k1 to the point k3 at −45 dB is defined as Tₖ₁₋ₖ₃. The standardization clock at the point k3 at −45 dB is defined as Tₖ₃. Then, the clock count L_{hsH} from the standardization clock t=0 to the transition area start point t=k1 is determined by L_{hsH}=Tₖ₃−Tₖ₁₋ₖ₃. Here, according to the filter specifications shown in FIG. 48, the frequency at −45 dB is 8.5 MHz. Accordingly, the standardization clock Tₖ₃ at the corresponding point k3 is Tₖ₃=8.5/80=0.10625. On the other hand, the clock count Tₖ₁₋ₖ₃ from the transition area start point k1 to the point k3 at −45 dB is determined by Tu−45*R_{trH} using the clock Tu₋₄₅ from the transition area start point (at t=0) in the standard function X_{F4} to the point at −45 dB, as well as the requested transition area ratio R_{trH}. As described above, Tu₋₄₅=0.067225, and R_{trH}=0.126963. Consequently, Tₖ₁₋ₖ₃=0.067225*0.126963=0.008535. Therefore, the clock count L_{hsH} up to the transition area start point k1 is determined to be L_{hsH}=0.10625−0.008535=0.097715.

Then, a calculation is made of the clock count L_{heH} from the standardization clock t=0 for the requested digital filter to the end point t=k4 of the transition area. The clock count from the start point k1 to end point k4 of the transition area is defined as Tₖ₁₋ₖ₄. Then, the clock count L_{heH} from the standardization clock t=0 to the transition area start point t=k4 is determined by L_{heH}=L_{hsH}+Tₖ₁₋ₖ₄. Here, the clock count Tₖ₁₋ₖ₄ from the start point k1 of the transition area to the end point k4 is determined by 0.5*R_{trH} using the clock count (=0.5) from the transition area start point (at t=0) to end point (at t=511/1024) in the standard function X_{F4}, as well as the requested transition area ratio R_{trH}. As described above, R_{trH}=0.126963, so that Tₖ₁₋ₖ₄=0.5*0.126963=0.063482. Therefore, the clock count L_{heH} from the standardization clock t=0 to the transition area end point t=k4 is determined to be L_{heH}=0.097715+0.063482=0.161197.

Then, a calculation is made of the clock count L_{hsL} from the standardization clock t=0 for the requested digital filter to the start point t=k5 of the transition area. The clock count from the transition area start point k5 to the point k2′ at −0.3 dB is defined as T_{k5-k2′}. The standardization clock at the point k2′ at −0.3dB is defined as T_{k2′}. Then, the clock count L_{hsL} from the standardization clock t=0 to the transition area start point t=k5 is determined by L_{hsL}=T_{k2′}−T_{k5-k2′}. Here, according to the filter specifications shown in FIG. 48, the frequency at −0.3 dB is 16 MHz. Accordingly, the standardization clock T_{k2′}at the corresponding point k2′ is T_{k2′}=16/80=0.2. On the other hand, the clock count T_{k5-k2′}from the transition area start point k5 to the point k2′ at −0.3 dB is determined by Td−0.3*R_{trL} using the clock count Td_{-0.3} from the transition area start point (at t=0) in the standard function X_{F1} to the point at −0.3 dB, as well as the requested transition area ratio R_{trL}. As described above, Td_{-0.3}=0.107878, and R_{trL}=0.134658. Consequently, T_{k5-k2′}=0.107878*0.134658=0.014527. Therefore, the clock count L_{hsL} up to the transition area start point k5 is determined to be L_{hsL}=0.2−0.014527=0.185473.

Then, a calculation is made of the clock count L_{heL} from the standardization clock t=0 for the requested digital filter to the end point t=k6 of the transition area. The clock count from the start point k5 to end point k6 of the transition area is defined as Tₖ₅₋ₖ₆. Then, the clock count L_{heL} from the standardization clock t=0 to the transition area end point t=k6 is determined by L_{heL}=L_{hsL}+Tₖ₅₋ₖ₆. Here, the clock count Tₖ₅₋ₖ₆ from the start point k5 of the transition area to the end point k6 is determined by 0.5*R_{trL} using the clock count (=0.5) from the transition area start point (at t=0) to end point (at t=511/1024) in the standard function X_{F1}, as well as the requested transition area ratio R_{trL}. As described above, R_{trL}=0.134658, so that Tₖ₅₋ₖ₆=0.5*0.134658=0.067329. Therefore, the clock count L_{heL} from the standardization clock t=0 to the transition area end point t=k6 is determined to be L_{heL}=0.185473+0.067329=0.252802.

As a result, the interpolation function I (BPF) is determined as shown in the following partition equations (Equations 13-1, 13-2, 13-3, 13-4, and 13-5).

$$\begin{matrix}I ( BPF ) = 0 \\ ( 0 / 1024 \leq t < {L}_{hsH} ) & ( Equation 13 \text{-} 1 ) \\ \begin{matrix}I ( BPF ) = 8 / 16 - 9 / 16 * cos \\ ( ( 2 π ( t - {L}_{hsH} ) / {R}_{trH} ) ) + \\ 1 / 16 * cos ( ( 6 π ( t - {L}_{hsH} ) / {R}_{trH} ) )\end{matrix} \\ ( {L}_{hsH} \leq t \leq {L}_{heH} ) & ( Equation 13 \text{-} 2 ) \\ I ( BPF ) = 1 \\ ( {L}_{heH} < t < {L}_{hsL} ) & ( Equation 13 \text{-} 3 ) \\ \begin{matrix}I ( BPF ) = 8 / 16 + 9 / 16 * cos \\ ( ( 2 π ( t - {L}_{hsL} ) / {R}_{trL} ) ) + \\ 1 / 16 * cos ( ( 6 π ( t - {L}_{hsL} ) / {R}_{trL} ) )\end{matrix} \\ ( {L}_{hsL} \leq t \leq {L}_{heL} ) & ( Equation 13 \text{-} 4 ) \\ I ( BPF ) = 0 \\ ( {L}_{heL} < t \leq 1023 / 1024 ) & ( Equation 13 \text{-} 5 )\end{matrix}$$

Specifically, the interpolation function I (BPF) determined is 1024 numerical sequences calculated by varying the value of the clock t in (Equations 13) from 0/1024 to 1023/1024. A graph showing these 1024 numerical sequences is almost similar to that in FIG. 26 which has been obtained by the first generation method. However, the resulting frequency characteristic enables the position of the transition area based on the design specifications shown in FIG. 48 to be realized more accurately than that determined by the first generation method.

Then, the frequency characteristic shown in FIG. 26 is made laterally symmetric with respect to the position of the standardization clock t=0.5. Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions corresponding to the clock t=512/1024 to 1023/1024. The resulting laterally symmetric 1024 numerical sequences are determined to be the numerical sequences for the input frequency characteristic in step S1 in FIG. 1.

FIG. 29 is a diagram showing the distribution of filter coefficients (which have not been subjected to a rounding process) for a band pass filter according to the specifications shown in FIG. 48, which have actually been determined, for example, to a calculation accuracy of 32 bits according to the procedure shown in FIGS. 1 and 2. Here, the absolute values of the filter coefficients are taken so that the positive and negative coefficients are all shown in the same quadrant.

As shown in FIG. 29, the filter coefficients determined by the filter designing method according to the present embodiment have the largest value in a central part of the distribution (the position of the standardization clock t=512/1024). The filter coefficients have a very sharp distribution such that their values are larger in a local area close to the center and smaller in the other areas and such that there are very large differences between the filter coefficient values close to the center and the peripheral filter coefficient values. This also applies to the filter coefficients determined according to the procedure shown in FIGS. 1 and 3.

Thus, even when filter coefficients with values smaller than a predetermined threshold are discarded by a rounding process, most of the major filter coefficients remain, which determine the frequency characteristic. Consequently, the frequency characteristic is not substantially affected. Further, the frequency characteristic obtained by the filter designing method according to the present embodiment exhibits a very significant attenuation. Consequently, the desired attenuation amount can be obtained even with a slight decrease in the number of bits.

This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

Thus, the present embodiment can reduce the filter coefficients by performing a rounding operation utilizing coefficient values. Consequently, windowing, as utilized in the prior art, is not necessarily required. As described above, the standard function input in step S1 has a finite-base impulse response. Thus, the number of filter coefficients designed on the basis of this standard function is originally smaller than that in the prior art. Accordingly, the standard function can be used as it is without the need for a rounding process. However, to further simplify the circuit, a rounding process is preferably executed to reduce the bits.

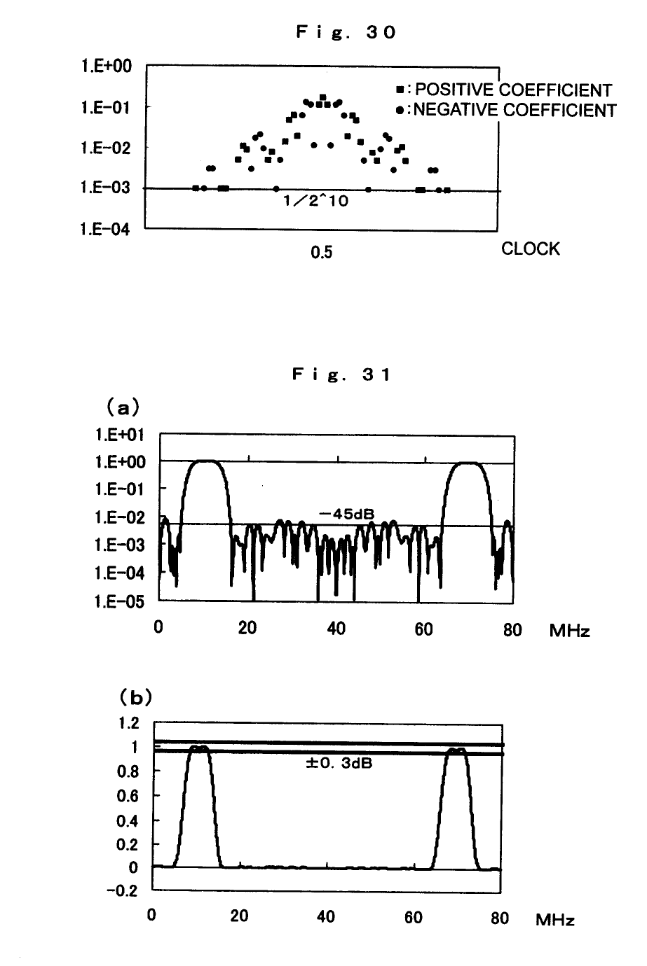

FIG. 30 is a distribution diagram showing filter coefficients obtained by setting x=10, that is, multiplying 32-bit filter coefficients determined by an inverse FFT, by a factor of 2¹⁰, dropping the resulting decimal fractions, and multiplying the result by a factor of 1/2¹⁰. In FIG. 30, the vicinity of center of the distribution, corresponding to t=512/1024, is enlarged. Further, FIG. 31 is a diagram showing the frequency amplitude characteristic of an FIR band pass filter implemented using the filter coefficients shown in FIG. 30. FIG. 31(a) shows gain on a logarithmic scale. FIG. 31(b) shows gain on a straight scale.

As shown in FIG. 30, the filter designing method according to the present embodiment finally determines only 53 filter coefficients. The present embodiment does not execute windowing for filter designing. As clearly seen in FIG. 31, this sharply reduces the ripple in the flat part of the frequency amplitude characteristic; the amount of ripple sufficiently falls within the range of ±0.3 dB. Further, after a rounding process, the out-of-band attenuation amount is about 45 dB. Thus, even only the 53 taps meet the specifications shown in FIG. 48.

As described above, the filter designing method according to the present embodiment enables the designing of a low pass filter, a high pass filter, and a band pass filter which exhibit an appropriate ripple characteristic. Further, the windowing operation is not necessarily required, and the taps can be sharply reduced without any windowing operation. Moreover, in a rounding operation, the filter coefficients are each multiplied by a factor of 2^{X}, with the product rounded to an integer. Multipliers used can thus be reduced. This enables the filter circuit to be implemented as an integrated circuit with a small area. Further, the determination of a filter coefficient of a desired frequency characteristic requires almost no trial and error processes, allowing an FIR filter to be easily designed.

Now, description will be given of the case in which a low pass filter according to the specifications shown in FIG. 46 is designed on the basis of a standard function different from the standard functions X_{F1} to X_{F3}. For example, description will be given below of the inputting of a different COS function as a standard function. This COS function is also preferably of a finite-base such that its impulse response has a finite value other than “0” in a local area and a value of “0” in all the other areas. In the description below, an example of the COS function is a standard function X_{S1} expressed by (Equation 14) shown below.
X_{S1}=1/2+1/2*cos(2πt) (Equation 14)

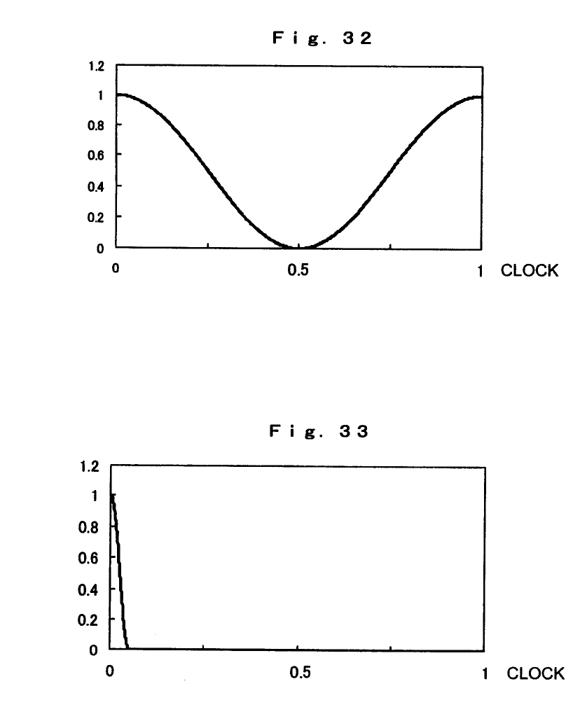

FIG. 32 is a graph showing the numerical sequences of the COS function shown in (Equation 14) (1024 numerical sequences calculated by varying the value for the clock t in (Equation 14) from 0/1024 to 1023/1024).

Either the above first or second generation method is also applicable to the determination of an interpolation function from the COS function X_{S1}. Now, description will be given of a method for determining an interpolation function according to the first generation method as a representative.

To generate an interpolation function according to the first generation method, first, the standard transition area ratio Rₜₛ of the COS function X_{S1} is determined. If the amplitude value of the pass band is set to “1”, the amplitude value of −0.3 dB is 0.966051. The amplitude value of −45 dB is 0.005623. A calculation is made of the value for the standardization clock Td corresponding to these amplitude values in the first half of the frequency characteristic of the COS function X_{S1} shown in FIG. 32. Then, Td_{-0.3}=0.059570, and Td₋₄₅=0.476563. Accordingly, the reference width Lₛ of transition area of the COS function X_{S1} is Lₛ=Td₋₄₅−Td_{-0.3}=0.416993. On the other hand, the number of standardization clocks in the first half of the frequency characteristic of the COS function X_{S1} is 0.5. Therefore, the standard transition area ratio Rₜₛ of the COS functions X_{S1} is determined to be Rₜₛ=Lₛ/0.5=0.833986.

Then, an interpolation function length Lᵢ is determined from the standard transition area ratio Rₜₛ. If a low pass filter according to specifications shown in FIG. 46 is to be designed, the specification for the transition area width is 8.5 to 11.8 MHz. The clock width of a sampling frequency of 80 MHz is 1024. Accordingly, the clock corresponding to 8.5 MHz is T_{8.5M}=109. The clock corresponding to 11.8 MHz is T_{11.8M}=151. The clock width L_{d} of the transition area to be designed is thus L_{d}=T_{11.8M}=T_{8.5M}=42. In this case, the interpolation function length Lᵢ is determined to be Lᵢ=42/Rₜₛ=50.360558.

To reduce the number of the taps in a low pass filter, it is desirable that the interpolation function length Lᵢ be an even integer larger than the calculated value. Thus, in this case, the interpolation function length Lᵢ is set to 52. An interpolation function II (LPF₁) with an interpolation function length Lᵢ of 52 clocks based on the COS function X_{S1} is determined as shown in the following partition equations (Equation 15-1) and (Equation 15-2).
II (LPF₁)=1/2+1/2*cos(2πt/52) (0/1024≦t≦51/1024) (Equation 15-1)
II (LPF₁)=0 (51/1024<t≦1023/1024) (Equation 15-2)

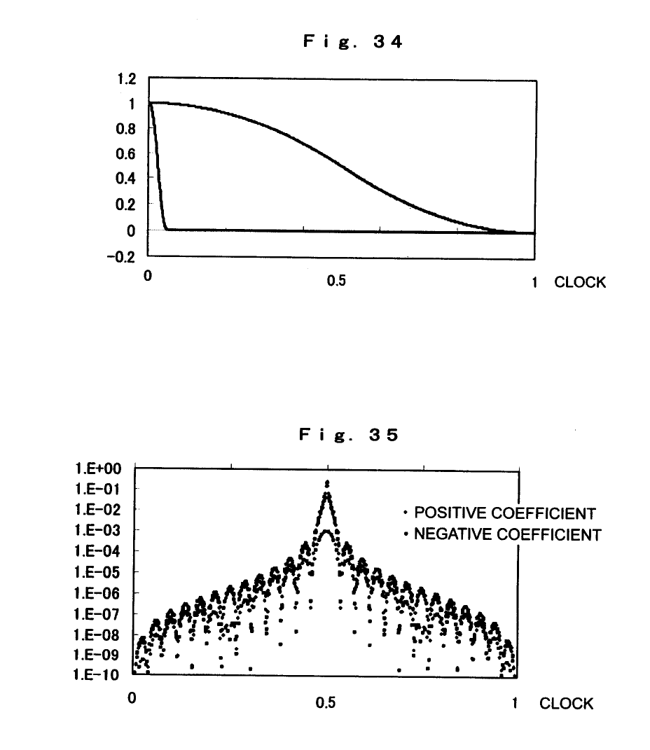

Specifically, the interpolation function II (LPF₁) determined is 1024 numerical sequences calculated by varying the value of the clock t in (Equations 15-1 ad 15-2) from 0/1024 to 1023/1024. FIG. 33 is a graph showing these 1024 numerical sequences.

Once the interpolation function II (LPF₁) is thus determined, its frequency characteristic is shifted in the direction of the frequency axis (clock direction) so that the shifted interpolation function II (LPF₁) joins the amplitude values “1” and “0” together. Specifically, 52 numerical sequences corresponding to the standardization clock t=0/1024 to 51/1024 determined by (Equation 15-1) are shifted to the positions of the clock t=i/1024 to (i+51)/1024 (i is an integer). The numerical sequences at the positions of the clock t=0/1024 to (i−1)/1024 are changed to “1”. And all the numerical sequences at the positions of the standardization clock t=(i+52)/1024 to 1023/1024 are changed to “0”.

Then, the frequency characteristic expressed by the numerical sequences thus generated is made laterally symmetric with respect to the position of the clock t=0.5. Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions of the clock t=512/1024 to 1023/1024. The resulting laterally symmetric 1024 numerical sequences are determined to be the numerical sequences for the input frequency characteristic in step S1 in FIG. 1.

Also in this case, the interpolation function shift amount i may be set at such a value as locates the amplitude value “0.5” of the interpolation function at positions on the frequency axis corresponding to its ⅛, 2/8, and ⅜. This simplifies the filter coefficients obtained by executing an inverse FFT on the numerical sequences for the input frequency characteristic in step S2 in FIG. 1. As a result, an FIR filter with a reduced number of taps can be designed.

Such a spline function as shown below can also be used as a standard function.
X_{S2}=1-2t² (0/1024≦t≦511/1024) (Equation 16-1)
X_{S2}=2 (t−1)² (511/1024<t≦1023/1024) (Equation 16-2)

FIG. 34 is a graph showing the standard function X_{S2} expressed by (Equations 16-1 and 16-2) and an interpolation function II (LPF₂) that is determined from the standard function X_{S2}. Further, FIG. 35 is a diagram showing the distribution of filter coefficients (which have not been subjected to a rounding process) which have been actually determined, for example, to a calculation accuracy of 32 bits according to the procedure shown in FIGS. 1 and 2, using the interpolation function II (LPF₂) Also in FIG. 35, the absolute value of the filter coefficient is taken so that the positive and negative coefficients are all shown in the same quadrant.

Further, a spline function X_{S3} expressed by (Equations 17-1 and 17-2) shown below may also be used as a standard function.
X_{S3}=1-8t² (0/1024<t≦255/1024) (Equation 17-1)
X_{S3}=8 (1/2−t)² (255/1024<t≦511/1024) (Equation 17-2)

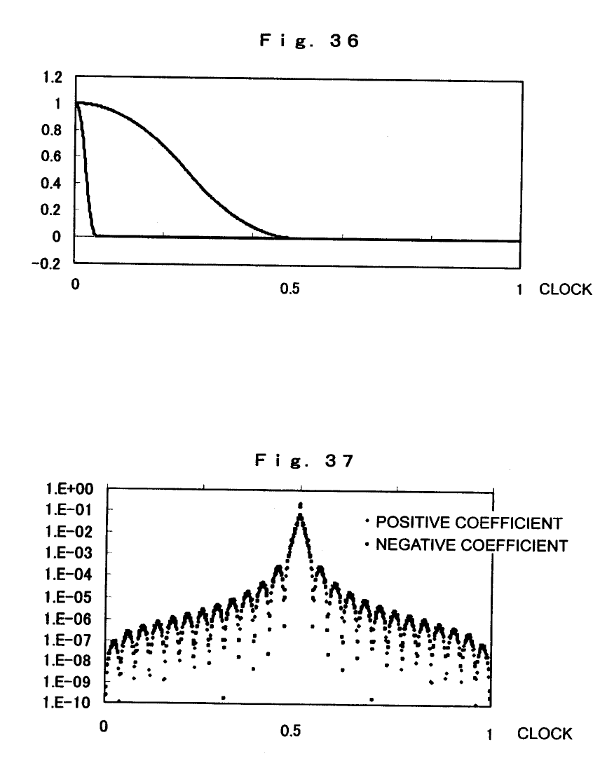

FIG. 36 is a graph showing the standard function X_{S3} expressed by (Equations 17-1 and 17-2) and an interpolation function II (LPF₃) that is determined from the standard function X_{S3}. Further, FIG. 37 is a diagram showing the distribution of filter coefficients (which have not been subjected to a rounding process) which have been actually determined, for example, to a calculation accuracy of 32 bits according to the procedure shown in FIGS. 1 and 2, using the interpolation function II (LPF₃) Also in FIG. 37, the absolute value of the filter coefficient is taken so that the positive and negative coefficients are all shown in the same quadrant.

As shown in FIGS. 35 and 37, the standard function X_{S2} or X_{S3}, such as the one shown in (Equations 16-1 and 16-2) or (Equations 17-1 and 17-2), also allows the filter coefficients determined by the filter designing method according to the present embodiment to exhibit the largest value in a central part of the distribution (the position of the standardization clock t=512/1024). The filter coefficients have a very sharp distribution such that their values are larger in a local area close to the center and smaller in the other areas and such that there are very large differences between the filter coefficient values close to the center and the peripheral filter coefficient values. This also applies to the filter coefficients determined according to the procedure shown in FIGS. 1 and 3.

Thus, even when filter coefficients with values smaller than a predetermined threshold are discarded by a rounding process, most of the major filter coefficients remain, which determine the frequency characteristic. Consequently, the frequency characteristic is not substantially affected. Further, the frequency characteristic obtained by the filter designing method according to the present embodiment exhibits a very significant attenuation. Consequently, the desired attenuation amount can be obtained even with a slight decrease in the number of bits. This enables a rounding process to sharply reduce the unwanted filter coefficients. For example, by dropping lower several bits of the filter coefficient to reduce the bits, it is possible to round all the filter coefficients with values smaller than the maximum value expressed only by the lower several bits, to “0” for discarding.

Spline functions applicable to the present embodiment are not limited to the above examples. That is, using a spline function of a finite-base enables preferable results to be achieved as is the case with FIGS. 35 and 37.

A linear function can also be used as a standard function. If a linear function is used as a standard function, the standard function X_{L} is expressed by the following partition equations (Equation 18-1) and (Equation 18-2).
X_{L}=1−t/512 (0/1024≦t≦511/1024) (Equation 18-1)
X_{L}=0 (511/1024<t≦1023/1024) (Equation 18-2)

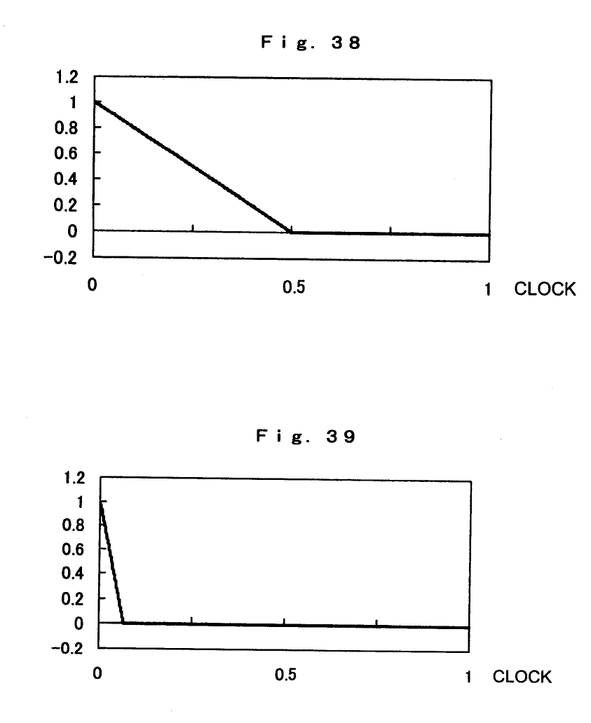

FIG. 38 is a graph showing the numerical sequences of the linear function X_{L} shown in (Equations 18-1 and 18-2).

Either the above first or second generation method is also applicable to the determination of an interpolation function from the linear function X_{L}. Now, description will be given of a method for determining an interpolation function according to the first generation method as a representative.

To generate an interpolation function according to the first generation method, first, the standard transition area ratios Rₜₛ of the linear function X_{L} is determined. If the amplitude value of the pass band is set to “1”, the amplitude value of −0.3 dB is 0.966051. The amplitude value of −45 dB is 0.005623. A calculation is made of the values for the standardization clock count Td corresponding to these amplitude values in the first half of the frequency characteristic of the linear function X_{L} shown in FIG. 38. Then, Td_{-0.3}=0.016602, and Td₋₄₅=0.497070. Accordingly, the reference width Lₛ of transition area of the linear function X_{L} is L_{s=Td}₋₄₅−Td_{-0.3}=0.480468. On the other hand, the number of standardization clocks in the first half of the frequency characteristic of the linear function X_{L} is 0.5. Therefore, the standard transition area ratio Rₜₛ of the linear functions X_{L} is determined to be Rₜₛ=Lₛ/0.5=0.960936.

Then, an interpolation function length Lᵢ is determined from the standard transition area ratio Rₜₛ. If a low pass filter according to specifications shown in FIG. 46 is to be designed, the specification for the transition area width is 8.5 to 11.8 MHz. The clock width of a sampling frequency of 80 MHz is 1024. Accordingly, the clock corresponding to 8.5 MHz is T_{8.5M}=109. The clock corresponding to 11.8 MHz is T_{11.8M}=151. The clock width L_{d} of the transition area to be designed is thus L_{d}=T_{11.8M}−T_{8.5M}=42. In this case, the interpolation function length Lᵢ is determined to be Lᵢ=42/Rₜₛ=42/0.96093=43.707385.

To reduce the number of taps in a low pass filter, it is desirable that the interpolation function length Lᵢ be an even integer larger than the calculated value. Thus, in this case, the interpolation function length Lᵢ is set to 44. An interpolation function III (LPF) with an interpolation length Lᵢ of 44 clocks based on the linear function X_{L} is determined as shown in the following partition equations (Equation 19-1) and (Equation 19-2).
III (LPF)=1−t/44 (0/1024≦t≦43/1024) (Equation 19-1)
III (LPF)=0 (43/1024<t≦1023/1024) (Equation 19-2)

Specifically, the interpolation function III (LPF) determined is 1024 numerical sequences calculated by varying the value of the clock t in (Equations 19-1 and 19-2) from 0/1024 to 1023/1024. FIG. 39 is a graph showing these 1024 numerical sequences.

Once the interpolation function III (LPF) is thus determined, its frequency characteristic is shifted in the direction of the frequency axis (clock direction) so that the shifted interpolation function III (LPF) joins the amplitude values “1” and “0” together. Specifically, 44 numerical sequences determined by (Equation 19-1) and corresponding to the standardization clock t=0/1024 to 43/1024 are shifted to the positions of the clock t=i/1024 to (i+43) /1024 (i is an integer). And all the numerical sequences at the positions of the clock t=0/1024 to (i−1)/1024 are changed to “1”. And all the numerical sequences at the positions of the standardization clock t=(i+44)/1024 to 1023/1024 are changed to “0”.

Then, the frequency characteristic expressed by the numerical sequences thus generated is made laterally symmetric with respect to the position of the clock t=0.5. Specifically, the arrangement of all the numerical sequences except the one corresponding to the standardization clock t=0/1024, that is, the numerical sequences corresponding to the clock t=1/1024 to 511/1024, is reversed. The reversed numerical sequences are copied to the positions of the clock t=512/1024 to 1023/1024. The resulting laterally symmetric 1024 numerical sequences are determined to be the numerical sequences for the input frequency characteristic in step S1 in FIG. 1.

Also in this case, the interpolation function shift amount i may be set at such a value as locates the amplitude value “0.5” of the interpolation function at positions on the frequency axis corresponding to its ⅛, 2/8, and ⅜. This simplifies the filter coefficients obtained by executing an inverse FFT on the numerical sequences for the input frequency characteristic in step S2 in FIG. 1. As a result, an FIR filter with a reduced number of taps can be designed.

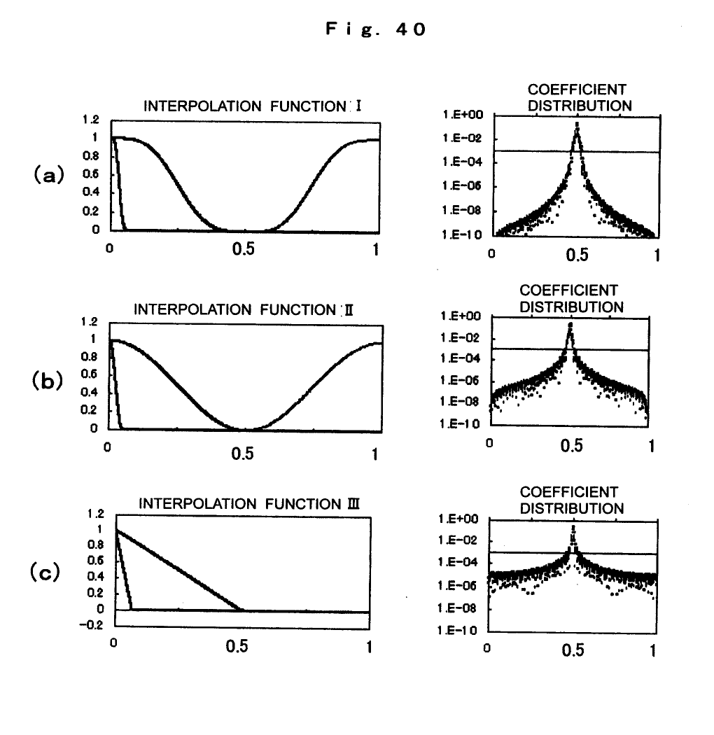

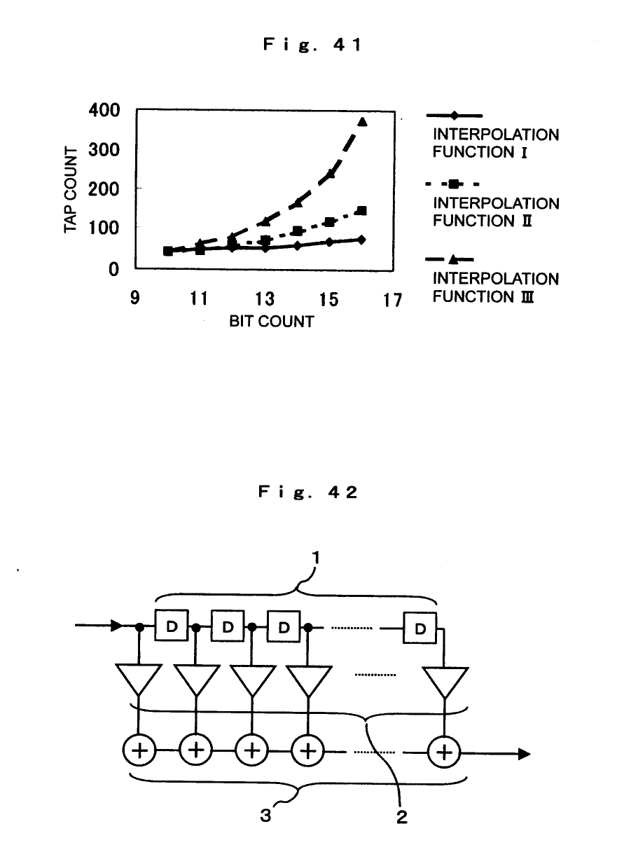

FIG. 40 is a diagram showing the three types of standard functions X_{F1}, X_{S1}, and X_{L}, shown in (FIG. 1), (FIG. 14), and (FIGS. 18-1 and 18-2), respectively, the three types of interpolation functions I (LPF₁), II (LPF₁), and III (LPF), calculated from the standard functions, and the distributions of filter coefficients (which have not been subjected to a rounding process) obtained by executing an inverse FFT on input frequency characteristics determined by frequency-shifting these interpolation functions. FIGS. 40(a) and 40(b) correspond to (Equation 1) and (Equation 14), respectively. FIG. 40(c) corresponds to (Equations 18-1 and 18-2). Further, FIG. 41 is a diagram showing the relationship between the value of x (number of bits x after rounding) that is used for a rounding operation and the number of taps required.

As shown in FIG. 40, compared to the COS function shown in (FIG. 14) and the linear function shown in (FIGS. 18-1 and 18-2), the function shown in (Equation 1) provides a sharp distribution with large differences between filter coefficients in the vicinity of the center and peripheral filter coefficients. Thus, even with the value x increased more than 10 by a rounding operation, an increase in the number of taps required is much smaller than that with the COS function or the linear function.

In general, the out-of-band attenuation amount of the filter is limited by the number of bits that can be supported by hardware to be implemented. Accordingly, if there are no limitations on hardware scale, an out-of-band attenuation characteristic with more significant attenuation can be provided by increasing the number of bits x resulting from a rounding process. If a filter is designed using the standard function shown in (Equation 1), even when a filter coefficient resulting from a rounding process is made up of 16 bits, the number of taps hardly increases and the out-of-band attenuation amount of the frequency characteristic can be increased above −45 dB.

In contrast, when the COS function, the spline function, or the linear function is used as a standard function, the number of taps required increases consistently if the number of bits x of a filter coefficient resulting from a rounding process is increased. However, reducing the number of bits in a filter coefficient to some degree enables the number of required taps to be reduced to a number equivalent to that achieved with the function shown in (Equation 1). Consequently, under the conditions under which the number of bits can be reduced to some degree by a rounding operation, a filter designing method can be effectively used which uses the COS function, the spline function, or the linear function as a standard function.

With a 12-bit accuracy, which is often used in the field of digital filters, no marked difference occurs in tap count among the function shown in (Equation 1), the COS function shown in (Equation 14), and the linear function shown in (Equations 18-1 and 18-2). Thus, the filter designing method is effective regardless of whichever function is used as a standard function.

An apparatus for realizing the digital filter designing method according to the above present embodiment can be implemented using a hardware configuration, a DSP, or software. If the filter designing apparatus according to the present embodiment is to be implemented, for example, by software, it is actually composed of a CPU, or an MPU, a RAM, or a ROM in a computer. In this case, the apparatus can be implemented by operating a program stored in the RAM or ROM or a hard disk.

For example, the functions of a spreadsheet installed in a personal computer or the like can be used to execute inputting of a standard function, calculation of an interpolation function from the standard function, frequency shifting of the interpolation function, an inverse FFT operation on an input frequency characteristic generated by shifting the interpolation function, a rearrangement operation on numerical sequences, a rounding operation, and the like. In this case, the operations are actually performed by the CPU, ROM, RAM, or the like in the personal computer or the like in which the spreadsheet is installed.

The filter designing apparatus according to the present embodiment may comprise a table information storage section that stores table information on attenuation values starting with 0 dB which are associated with standardization clock values corresponding to the attenuation values on a predetermined standard function, an input device that inputs information on requested specifications as shown in FIGS. 46 to 48, and a calculation device that calculates an interpolation function using the input information on the required specifications and the above table information. With this configuration, simply by inputting the information on the required specifications to the circuit using the input device, it is possible to automatically determine an interpolation function (input frequency characteristic to be subjected to an inverse FFT) that meets the required specifications.

Alternatively, filter coefficients determined may be automatically subjected to FFT, with the results shown on a display screen as a frequency characteristic diagram. This enables the frequency characteristic of the designed filter to be visually checked. Therefore, filter designing can be more easily achieved.

To actually implement a digital filter in an electronic device or on a semiconductor IC, an FIR filter may be constructed so as to have, as filter coefficients, numerical sequences finally determined by the filter designing apparatus as described above. Specifically, as shown in FIG. 42, a plurality of D-type flip flops 1, a plurality of coefficient multipliers 2, and a plurality of adders 3 are simply used to construct one digital filter. Final filter coefficients determined according to such a procedure as described above are set in the plurality of multipliers 2 in the digital filter. If the filter coefficients are multiplied by a factor of 2^{X}, with the results rounded to integers, then the digital filter can be configured as shown in FIG. 43.

As described above in detail, the present embodiment inputs a standard function to the circuit and calculates an interpolation function from the standard function to determine an input frequency characteristic. Then, an inverse FFT is executed on a numerical sequence indicative of the input frequency characteristic to determine filter coefficients. Consequently, the coefficients for an FIR digital filter which allow a desired frequency characteristic to be provided can be easily determined without any special mathematical or electrical engineering knowledge. In particular, the same technique can be used to easily design not only a low pass filter but also a high pass filter, a band pass filter, a band elimination filter, or a comb filter.

Further, the present embodiment does not necessarily require a windowing operation for reducing the number of filter coefficients. Instead, a numerical rounding operation enables the number of filter coefficients to be reduced without lowering the accuracy of the frequency characteristic. The present embodiment can also simplify the filter coefficient values by performing an arithmetic operation on a numerical sequence determined by an inverse FFT to obtain integers. This makes it possible to sharply reduce required multipliers, filter components, to simplify the filter configuration. Furthermore, a desired frequency characteristic can be accurately provided.

The above embodiment has been described in conjunction with the usage of the standard functions X_{F1} to X_{F6}, X_{S1} to X_{S3}, and X_{L}. However, standard functions that can be used for the present invention are not limited to them.

The above embodiment has been described in conjunction with the process of multiplying a numerical sequence by a factor of 2^{X} and rounding down the resulting decimal fractions, as an example of an operation for making filter coefficients integers. However, the present invention is not limited to this. For example, the numerical sequence may be multiplied by a factor of 2^{X} with the resulting decimal fractions rounded up or off.

As another example in which filter coefficients are made integers, a numerical sequence of filter coefficients may be multiplied by a factor of N (N is a value other than the power of 2), with the resulting decimal fractions rounded (rounded down, up, or off). To perform a rounding operation on a numerical sequence multiplied by a factor of N, the digital filter can be configured as shown in FIG. 44 and described below. The plurality of coefficient multipliers 2 individually multiply output signals from the taps of a tapped delay line made up of the plurality of delayers (D type flip flops) 1 by integral filter coefficients. The plurality of adders 3 add up all the resulting multiplication outputs. A multiplier 5 collectively multiplies the result by a factor of 1/N. Further, integral filter coefficients can be expressed by a binary addition such as 2ⁱ+2^{j}+ . . . (i and j are arbitrary integers). The coefficient multipliers can thus be composed of a bit shift circuit in place of multipliers. This makes it possible to simplify the configuration of a digital filter to be implemented.

Further, multiplying the numerical sequence by a factor of 2^{X} enables the filter coefficients to be rounded in bits. In contrast, multiplying the numerical sequence by a factor of N enables inter-bit rounding to be executed on the filter coefficients. The rounding process in bits refers to a process of making the coefficient values integral multiples of 1/2^{X}; if for example, the coefficient values are multiplied by a factor of 2^{X}, with the resulting decimal fractions rounded down, then all the numerical values belonging to the range from 2^{X} to 2^{x+1} are rounded to 2^{X}. Further, the inter-bit rounding process refers to a process of making the coefficient values integral multiples of 1/N; if for example, the coefficient values are multiplied by a factor of N (for example, 2^{x-1}<N<2^{X}), with the resulting decimal fractions rounded down, then all the numerical values belonging to the range from N to N+1 are rounded to N. The rounding operation on the coefficient values multiplied by a factor of N makes it possible to adjust the filter coefficients to be made integers to arbitrary values other than the power of 2. This enables the precise adjustment of the number of filter coefficients (number of taps) that are used for the digital filter.

Alternatively, as an example of a rounding operation with filter coefficients made integers, all y-bit filter coefficients with a data value of smaller than 1/2^{X} may be determined to be zero, while for y-bit filter coefficients with a data value of at least 1/2^{X}, the data values may be multiplied by factor of 2^{x+X} (x+X<y), with the resulting decimal fractions rounded (rounded down, up, or off).

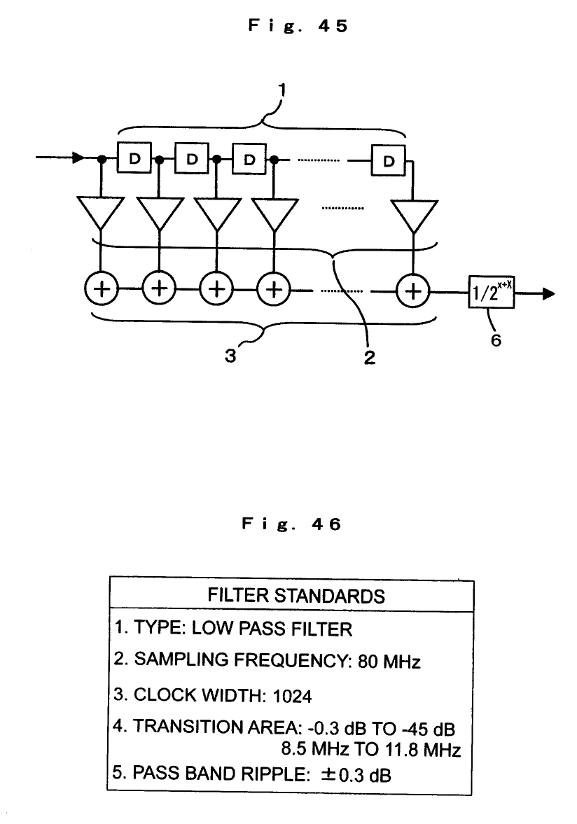

To perform such a rounding operation as described above, the digital filter can be configured as shown in FIG. 45 and described below. The plurality of coefficient multipliers 2 individually multiply output signals from the taps of a tapped delay line made up of the plurality of delayers (D type flip flops) 1. The plurality of adders 3 add up all the resulting multiplication outputs by integral filter coefficients. A shift operation unit 6 collectively multiplies the result by a factor of 1/2^{x+X}. Further, integral filter coefficients can be expressed by a binary addition such as 2ⁱ+2^{j}+ . . . (i and j are arbitrary integers). The coefficient multipliers can thus be composed of a bit shift circuit in place of multipliers. This makes it possible to simplify the configuration of a digital filter to be implemented.

Further, by considering all data values of smaller than 1/2^{X} to be zero to round them down, it is possible to sharply reduce the number of required filter coefficients (taps) and to determine accurate filter coefficients composed of (x+X) bits, that is, more than x bits. This enables a more appropriate frequency characteristic to be obtained.

Further, the above embodiments are only specific examples for carrying out the present invention and are not intended to limitedly interpret the technical scope of the present invention. That is, the present invention can be carried out in various manners without departing from its sprit or major characteristics.

### INDUSTRIAL APPLICABILITY

The present invention is useful for an FIR digital filter of a type that comprises a tapped delay line made up of a plurality of delayers and which multiplies output signals from the taps of the tapped delay line by respective filter coefficients, with the multiplication results added up for output. The present invention is also useful for a method for designing this FIR digital filter.

1-24. (canceled)

25. A method of designing a digital filter of a type which multiplies data from taps of a tapped delay line comprising a plurality of lines, by respective coefficients and which adds up multiplication results for output, the method comprising:
a first step of inputting a standard function such that an impulse response from the standard function has a finite value other than zero only in a given area and a value of zero in all the other areas;
a second step of determining a ratio of a transition area indicative of an area of a predetermined part between a pass band and a stop band of a frequency amplitude characteristic determined by the standard function input in the first step, to the entire area indicative of an area from the pass band to the stop band;
a third step of determining an interpolation function length indicative of the length of an effective area in a direction of a frequency axis of the frequency amplitude characteristic of an interpolation function to be determined, from the transition area ratio determined in the second step and the transition area width based on specifications for the filter to be designed;
a fourth step of using the interpolation function length determined in the third step and the standard function input in the first step to determine the interpolation function of a finite length which joins a maximum amplitude value at a predetermined frequency position of the frequency amplitude characteristic and a minimum amplitude value at a frequency position that is at a distance equal to the interpolation function length from the predetermined frequency position together, the interpolation function having a period shorter than the standard function by an amount corresponding to the interpolation function length;
a fifth step of shifting the frequency amplitude characteristic of the interpolation function determined in the fourth step by a desired amount in the direction of the frequency axis;
a sixth step of transforming the frequency amplitude characteristic of the interpolation function determined in the fifth step, into a laterally symmetric type to determine a numerical sequence indicative of the frequency amplitude characteristic corresponding to the specifications for the filter to be designed;
a seventh step of subjecting the numerical sequence determined in the sixth step to an inverse Fourier transformation and extracting real terms from a result of the inverse Fourier transformation;
an eighth step of rearranging a former half and a latter half of the numerical sequence comprising the real terms extracted in the seventh step; and
a ninth step of executing a rounding process of rounding lower several bits of data of predetermined bits in the numerical sequence calculated in the eighth step to reduce the bits,
wherein the numerical sequence obtained in the ninth step is determined to be the filter coefficients.

26. A method of designing a digital filter of a type which multiplies data from taps of a tapped delay line comprising a plurality of lines, by respective coefficients and which adds up multiplication results for output, the method comprising:
a first step of inputting a standard function such that an impulse response from the standard function has a finite value other than zero only in a given area and a value of zero in all the other areas;
a second step of determining a ratio of a transition area indicative of that area of a frequency amplitude characteristic determined according to the specification for the filter to be designed which contains amplitude values except a maximum amplitude value and a minimum amplitude value, to a transition area indicative of that area of a frequency amplitude characteristic determined according to the standard function which contains amplitude values except a maximum amplitude value and a minimum amplitude value;
a third step of using the transition area ratio determined in the second step to determine a start point and an end point of the transition area of the frequency amplitude characteristic determined according to the specifications for the filter to be designed;
a fourth step of using the transition area ratio determined in the second step, the start point and the end point of the transition area determined in the third step, and the standard function input in the first step to determine an interpolation function of a finite length which joins the start point and the end point of the transition area together and which has a period shorter than the standard function by an amount corresponding to the transition area ratio;
a fifth step of transforming the frequency amplitude characteristic of the interpolation function determined in the fourth step, into a laterally symmetric type to determine a numerical sequence indicative of the frequency amplitude characteristic corresponding to the specifications for the filter to be designed;
a sixth step of subjecting the numerical sequence determined in the fifth step to an inverse Fourier transformation and extracting real terms from a result of the inverse Fourier transformation;
a seventh step of rearranging a former half and a latter half of the numerical sequence comprising the real terms extracted in the sixth step; and
an eighth step of executing a rounding process of rounding lower several bits of data of predetermined bits in the numerical sequence calculated in the seventh step to reduce the bits,
wherein the numerical sequence obtained in the eighth step is determined to be the filter coefficients.

27. A device that designs a digital filter of a type which multiplies data from taps of a tapped delay line comprising a plurality of lines, by respective coefficients and which adds up multiplication results for output, the device comprising:
input means for inputting a standard function such that an impulse response from the standard function has a finite value other than zero only in a given area and a value of zero in all the other areas; and
calculation means for performing:
a first operation of determining a transition area ratio that is a ratio of a transition area indicative of an area of a predetermined part between a pass band and a stop band of a frequency amplitude characteristic determined by the standard function input in the first step, to the entire area indicative of an area from the pass band to the stop band,
a second operation of determining an interpolation function length indicative of the length of an effective area in a direction of a frequency axis of the frequency amplitude characteristic of an interpolation function to be determined, from the transition area ratio and the transition area width based on specifications for the filter to be designed,
a third operation of using the interpolation function length and the standard function to determine the interpolation function of a finite length which joins a maximum amplitude value at a predetermined frequency position of the frequency amplitude characteristic and a minimum amplitude value at a frequency position that is at a distance equal to the interpolation function length from the predetermined frequency position together, the interpolation function having a period shorter than the standard function by an amount corresponding to the interpolation function length,
a fourth operation of shifting the frequency amplitude characteristic of the interpolation function by a desired amount in the direction of the frequency axis,
a fifth operation of transforming the shifted frequency amplitude characteristic of the interpolation function into a laterally symmetric type to determine a numerical sequence indicative of the frequency amplitude characteristic corresponding to the specifications for the filter to be designed,
a sixth operation of subjecting the determined numerical sequence to an inverse Fourier transformation and extracting real terms from a result of the inverse Fourier transformation,
a seventh operation of rearranging a former half and a latter half of the numerical sequence comprising the extracted real terms, and
an eighth operation of executing a rounding process of rounding lower several bits of data of predetermined bits in the numerical sequence comprising the real terms to reduce the bits,
wherein the numerical sequence obtained by the eighth operation is determined to be the filter coefficients.

28. A device that designs a digital filter of a type which multiplies data from taps of a tapped delay line comprising a plurality of lines, by respective coefficients and which adds up multiplication results for output, the device comprising:
input means for inputting a standard function such that an impulse response from the standard function has a finite value other than zero only in a given area and a value of zero in all the other areas; and
calculation means for performing:
a first operation of determining a transition area ratio that is a ratio of a transition area indicative of that area of a frequency amplitude characteristic determined according to the specification for the filter to be designed which contains amplitude values except a maximum amplitude value and a minimum amplitude value, to a transition area indicative of that area of a frequency amplitude characteristic determined by the standard function which contains amplitude values except a maximum amplitude value and a minimum amplitude value,
a second operation of using the transition area ratio to determine a start point and an end point of the transition area of the frequency amplitude characteristic determined according to the specifications for the filter to be designed,
a third operation of using the transition area ratio, the start point and end point of the transition area, and the standard function to determine an interpolation function of a finite length which joins the start point and end point of the transition area together and which has a period shorter than the standard function by an amount corresponding to the transition area ratio,
a fourth operation of transforming the frequency amplitude characteristic of the interpolation function into a laterally symmetric type to determine a numerical sequence indicative of the frequency amplitude characteristic corresponding to the specifications for the filter to be designed,
a fifth operation of subjecting the determined numerical sequence to an inverse Fourier transformation and extracting real terms from a result of the inverse Fourier transformation,
a sixth operation of rearranging a former half and a latter half of the numerical sequence comprising the extracted real terms, and
a seventh operation of executing a rounding process of rounding lower several bits of data of predetermined bits in the numerical sequence comprising the real terms to reduce the bits,
wherein the numerical sequence obtained by the seventh operation is determined to be the filter coefficients.

29. A computer readable medium containing computer code thereon which, when executed by a computer, implements a digital filter designing program that functions to carry out the method steps of claim 25.

30. A computer readable medium containing computer code thereon which, when executed by a computer, carries out functions associated with said calculation means for performing recited in claim 27.

31. An FIR type digital filter having, as filter coefficients, a numerical sequence calculated using the designing method according to claim 25.

32. A method of generating a numerical sequence indicative of a frequency characteristic corresponding to specifications for an FIR digital filter to be designed, the method comprising:
a first step of inputting a standard function such that an impulse response from the standard function has a finite value other than zero only in a given area and a value of zero in all the other areas;
a second step of determining a ratio of a transition area indicative of an area of a predetermined part between a pass band and a stop band of a frequency amplitude characteristic determined by the standard function input in the first step, to the entire area indicative of an area from the pass band to the stop band;
a third step of determining an interpolation function length indicative of the length of an effective area in a direction of a frequency axis of the frequency amplitude characteristic of an interpolation function to be determined, from the transition area ratio determined in the second step and the transition area width based on specifications for the FIR digital filter to be designed;
a fourth step of using the interpolation function length determined in the third step and the standard function input in the first step to determine the interpolation function of a finite length which joins a maximum amplitude value at a predetermined frequency position of the frequency amplitude characteristic and a minimum amplitude value at a frequency position that is at a distance equal to the interpolation function length from the predetermined frequency position together, the interpolation function having a period shorter than the standard function by an amount corresponding to the interpolation function length; and
a fifth step of shifting the frequency amplitude characteristic of the interpolation function determined in the fourth step by a desired amount in the direction of the frequency axis to determine a numerical sequence for a frequency amplitude characteristic corresponding to the specifications for the FIR digital filter to be designed.

33. A method of generating a numerical sequence indicative of a frequency characteristic corresponding to specifications for an FIR digital filter to be designed, the method comprising:
a first step of inputting a standard function such that an impulse response from the standard function has a finite value other than zero only in a given area and a value of zero in all the other areas;
a second step of determining a transition area ratio that is a ratio of a transition area indicative of that area of a frequency amplitude characteristic determined according to the specifications for the FIR digital filter to be designed which contains amplitude values except a maximum amplitude value and a minimum amplitude value, to a transition area indicative of that area of a frequency amplitude characteristic determined by the standard function which contains amplitude values except a maximum amplitude value and a minimum amplitude value;
a third step of using the transition area ratio determined in the second step to determine a start point and an end point of the transition area of the frequency amplitude characteristic determined according to the specifications for the FIR digital filter to be designed; and
a fourth step of using the transition area ratio determined in the second step, the start point and the end point of the transition area determined in the third step, and the standard function input in the first step to determine an interpolation function of a finite length which joins the start point and end point of the transition area together and which has a period shorter than the standard function by an amount corresponding to the transition area ratio.

34. A device that generates a numerical sequence indicative of a frequency characteristic corresponding to specifications for an FIR digital filter to be designed, the device comprising;
input means for inputting a standard function such that an impulse response from the standard function has a finite value other than zero only in a given area and a value of zero in all the other areas; and
calculation means for performing:
a first operation of determining a transition area ratio that is a ratio of a transition area indicative of an area of a predetermined part between a pass band and a stop band of a frequency amplitude characteristic determined by the standard function input in the first step, to the entire area indicative of an area from the pass band to the stop band,
a second operation of determining an interpolation function length indicative of the length of an effective area in a direction of a frequency axis of the frequency amplitude characteristic of an interpolation function to be determined, from the transition area ratio and the transition area width based on specifications for the FIR digital filter to be designed,
a third operation of using the interpolation function length and the standard function to determine the interpolation function of a finite length which joins a maximum amplitude value at a predetermined frequency position of the frequency amplitude characteristic and a minimum amplitude value at a frequency position that is at a distance equal to the interpolation length from the predetermined frequency position together, the interpolation function having a period shorter than the standard function by an amount corresponding to the interpolation function length, and
a fourth operation of shifting the frequency amplitude characteristic of the interpolation function by a desired amount in the direction of the frequency axis to determine a numerical sequence for a frequency amplitude characteristic corresponding to the specifications for the FIR digital filter to be designed.

35. A device that generates a numerical sequence indicative of a frequency characteristic corresponding to specifications for an FIR digital filter to be designed, the device comprising;
input means for inputting a standard function such that an impulse response from the standard function has a finite value other than zero only in a given area and a value of zero in all the other areas; and
calculation means for performing a first operation of determining a transition area ratio that is a ratio of a transition area indicative of that area of a frequency amplitude characteristic determined according to the specifications for the FIR digital filter to be designed which contains amplitude values except a maximum amplitude value and a minimum amplitude value, to a transition area indicative of that area of a frequency amplitude characteristic determined by the standard function which contains amplitude values except a maximum amplitude value and a minimum amplitude value, a second operation of using the transition area ratio to determine a start point and an end point of the transition area of the frequency amplitude characteristic determined according to the specifications for the FIR digital filter to be designed, a third operation of using the transition area ratio, the start point and end point of the transition area, and the standard function to determine an interpolation function of a finite length which joins the start point and end point of the transition area together and which has a period shorter than the standard function by an amount corresponding to the transition area ratio.

36. A computer readable medium containing computer code thereon which, when executed by a computer, carries out functions that generate a numerical sequence for a desired frequency characteristic according to the method steps of claim 32.

37. A computer readable medium containing computer code thereon which, when executed by a computer, carries out functions associated with said calculation means for performing recited in claim 34.

38. A computer readable medium containing computer code thereon which, when executed by a computer, implements a digital filter designing program that functions to carry out the method steps of claim 26.

39. A computer readable medium containing computer code thereon which, when executed by a computer, carries out functions associated with said calculation means for performing recited in claim 28.

40. An FIR type digital filter having, as filter coefficients, a numerical sequence calculated using the designing method according to claim 26.

41. An FIR type digital filter having, as filter coefficients, a numerical sequence calculated using the designing device according to claim 27.

42. An FIR type digital filter having, as filter coefficients, a numerical sequence calculated using the designing device according to claim 28.

43. A computer readable medium containing computer code thereon which, when executed by a computer, carries out functions that generate a numerical sequence for a desired frequency characteristic according to the method steps of claim 33.

44. A computer readable medium containing computer code thereon which, when executed by a computer, carries out functions associated with said calculation means for performing recited in claim 35.
